(19) United States
(12) Patent Application Publication
(10) Pub. No.: US 2025/0353960 A1
(43) Pub. Date: Nov. 20, 2025

(54) SPRAY DRYING AID FOR A RE-DISPERSIBLE DISPERSION POWDER

(71) Applicant: BASF SE, Ludwigshafen am Rhein (DE)

(72) Inventors: Christian SCHMIDTKE, Lemfoerde (DE); Elena WOLF, Ludwigshafen am Rhein (DE); Christian SCHADE, Ludwigshafen am Rhein (DE); Anna Maria CRISTADORO, Lemfoerde (DE); Roland BAUMSTARK, Ludwigshafen Am Rhein (DE); Torben GAEDT, Traunstein (DE); Klaus SEIP, Ludwigshafen am Rhein (DE); Martin WINKLBAUER, Trostberg (DE); Motonori YAMAMOTO, Ludwigshafen am Rhein (DE); Olivier FLEISCHEL, Ludwigshafen am Rhein (DE); Benedikt CRONE, Ludwigshafen am Rhein (DE)

(21) Appl. No.: 18/872,960

(22) PCT Filed: Jun. 9, 2023
(86) PCT No.: PCT/EP2023/065447

§ 371 Date: Dec. 9, 2024

(30) Foreign Application Priority Data
Jun. 10, 2022 (WO) PCT/EP2022/065861

(51) Int. Cl. C08G 73/06

(52) U.S. Cl. CPC C08G 73/0611

(57) ABSTRACT

The present invention is directed to specific pyrrolidone-containing polymers (PP) and its use as a spray-drying additive (also known as spray drying aid; SDA) for an aqueous polymer dispersion. The present invention is further directed to a process of manufacturing a redispersible dispersion powder (RDP) comprising said SDAs, as well as RDPs comprising said SDAs and certain applications thereof. In addition, the present invention is directed to a process for producing the specific pyrrolidone-containing polymers (PP).

The present invention is directed to the use of specific pyrrolidone-containing polymers (PP) as spray-drying additive (also known as spray drying aid; SDA) for an aqueous polymer dispersion. The present invention is further directed to a process of manufacturing a re-dispersible dispersion powder (RDP) comprising said SDAs, as well as RDPs comprising said SDAs and certain applications thereof. In addition, the present invention is directed to specific pyrrolidone-containing polymers (PP) and a process for producing the same.

An appropriate method for converting an aqueous dispersion to a re-dispersible dispersion powder (RDP) is spray drying. This involves spraying and dewatering the aqueous dispersion in a hot air stream. In order to assure spray drying of the dispersion and re-dispersibility of the dispersion powder, a spray-drying additive (SDA) is generally added to the aqueous dispersion. During the spray-drying process, it is assumed that the SDA forms a protective shell around the dispersion particles, which protects the particles from filming during the spray drying.

Formaldehyde condensation products can be used as SDA, such as melamine-formaldehyde (DE 2049114 A1), phenol sulfonic acid-formaldehyde (WO 98/03576 A1), and naphthalene sulfonic acid-formaldehyde condensation products (WO 98/03577 A1). However, these SDAs described in the prior art have disadvantages. For example, they discolor the dispersion powder, they show coloration effects (yellow-brown discoloration) under UV light, and suffer from formaldehyde emission during fabrication and/or in the application system.

Hence, there is an ongoing need to provide suitable spray drying aids for an aqueous polymer dispersion, a process of manufacturing a re-dispersible dispersion powder comprising the same, as well as re-dispersible dispersion powders comprising said SDA.

Against this background, it is an object of the present invention to provide a suitable spray drying aid for an aqueous polymer dispersion. In this connection, it is an object of the present invention to provide an SDA having less discoloration. Further, it is an object of the present invention to provide an SDA having reduced formaldehyde emission during fabrication and/or in the application system (e.g. in powder paint or construction material composition). Further, it is an objection of the present invention to provide an environmentally friendly SDA. In addition, it is an object of the present invention to provide a pyrrolidone-containing polymer which is biodegradable and to provide a process for its preparation. It is further an object of the present invention to provide a re-dispersible dispersion powder having suitable re-dispersibility. It is an additional object of the present invention to provide a stable powder paint and/or construction material composition. In this connection, it is an object of the present invention to provide a powder paint and/or construction material composition having a reduced discoloration and/or a reduced formaldehyde emission. Further, it is an object of the present invention to provide a durable paint and/or construction material.

It has surprisingly been found that at least one of these objects can be achieved by using a pyrrolidone-containing polymer (PP) as claimed and disclosed herein as SDA. It has further been found that the powder paint and/or construction material composition as defined herein provide improved wet scrub resistance as well as suitable re-dispersibility. The inventors have further identified suitable biodegradable pyrrolidone-containing polymers that can be easily manufactured.

In a first aspect, the present invention relates to a pyrrolidone-containing polymer (PP) comprising at least one (monomeric) unit of the general formulae (I) to (III)

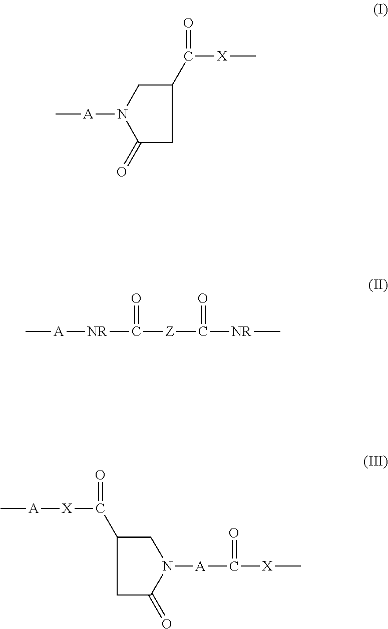

wherein R is independently hydrogen, C₁-C₄-alkyl, or two radicals R are linked to one another to form a six-membered ring;
X is —O— or —NR;
A is independently selected from the group consisting of C₁-C₂₀-alkanediyl, C₃-C₂O-cycloalkanediyl, and C₆-C₂₀-arylene,
wherein the C₁-C₂₀-alkanediyl is optionally interrupted by one or more non-adjacent oxygen atoms, sulfur atoms, or functional groups —NR— where the nitrogen atom is optionally protonated or quarternized, —CO—, —CO—O—, —CO—NR—, —SO—, or —SO₂—,
wherein the C₁-C₂₀-alkanediyl and the C₃-C₂₀-cycloalkanediyl optionally carry at least one functional group selected from the group consisting of C(═O)R² and SO₃H, wherein
R² is selected from the group consisting of Cl, Br and OR³, wherein
R³ is selected from the group consisting of H, C₁-C₁₀-alkyl, C₃-C₁₀-cycloalkyl and C₂-C₁₅-alkenyl,
wherein the C₆-C₂₀-arylene is optionally interrupted by oxygen, sulfur, —NR—, —SO—, or —SO₂— and optionally substituted by —COOH or —SO₃H, or a mixture of such groups;
Z is a group of formula (IV)

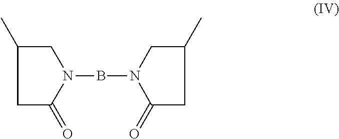

in which B is C₁-C₂₀-alkanediyl, which optionally is interrupted by one or more non-adjacent oxygen atoms, sulfur atoms or functional groups —NR— where the nitrogen atom is optionally protonated or quaternized, —CO—, —CO—O—, —CO—NR—, —SO— or —SO₂—, and optionally carries additional functional groups —COOH or —SO₃H, C₆-C₂₀-cycloalkanediyl or a mixture of such groups
or a mixture of the group of formula (IV) with groups A;
for use as spray drying aid for an aqueous polymer dispersion. The first aspect also covers the use of said pyrrolidone-containing polymer (PP) as spray drying aid for an aqueous polymer dispersion.

In the following, preferred embodiments of the pyrrolidone-containing polymer (PP) and of the aqueous polymer dispersion are described in further detail. It is to be understood that each preferred embodiment is individually encompassed as well as in combination with any other(s) of the preferred embodiments.

In a preferred embodiment A1 of the first aspect, the pyrrolidone-containing polymer (PP) comprises at least one unit of the general formulae (I) to (II)

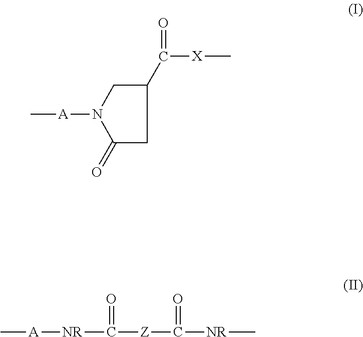

wherein R is independently hydrogen or C₁-C₂-alkyl;
X is —NR;
A is independently selected from the group consisting of C₁-C₂₀-alkanediyl, which optionally carries at least one functional group selected from the group consisting of C(═O)R² and SO₃H, wherein
R² is selected from the group consisting of Cl, Br and OR³, wherein
R³ is selected from the group consisting of H, C₁-C₁₀-alkyl, C₃-C₁₀-cycloalkyl and C₂-C₁₅-alkenyl;
Z is a group of formula (IV)

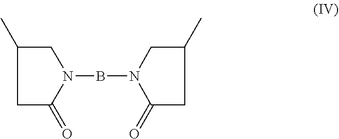

in which B is C₁-C₂₀-alkylene, which optionally carries additional functional groups —COOH or —SO₃H, or a mixture of the group of formula (IV) with groups A.

In a preferred embodiment A2 of the first aspect, the aqueous polymer dispersion comprises a (co)polymer selected from the group consisting of acrylic acid ester polymer, acrylic-styrene copolymer, styrene-butadiene-based copolymer, vinyl acetate polymer, and ethylene-vinyl acetate copolymer, preferably selected from the group consisting of acrylic-styrene copolymer, styrene-butadiene-based copolymer, and ethylene-vinyl acetate copolymer, more preferably acrylic-styrene copolymer.

In a second aspect, the present invention relates to a process of manufacturing a re-dispersible dispersion powder (RDP), the process comprising the steps of
i) mixing a pyrrolidone-containing polymer (PP) comprising at least one unit of the general formulae (I) to (III)

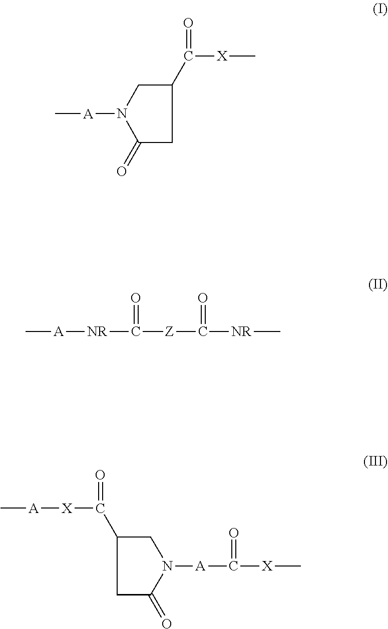

wherein R is independently hydrogen, C₁-C₄-alkyl, or two radicals R are linked to one another to form a six-membered ring;
X is —O— or —NR;
A is independently selected from the group consisting of C₁-C₂₀-alkanediyl, C₃-C₂₀-cycloalkanediyl, and C₆-C₂₀-arylene,
wherein the C₁-C₂₀-alkanediyl is optionally interrupted by one or more non-adjacent oxygen atoms, sulfur atoms, or functional groups —NR— where the nitrogen atom is optionally protonated or quarternized, —CO—, —CO—O—, —CO—NR—, —SO—, or —SO₂—,
wherein the C₁-C₂₀-alkanediyl and the C₃-C₂₀-cycloalkanediyl optionally carry at least one functional group selected from the group consisting of C(═O)R² and SO₃H, wherein
R² is selected from the group consisting of Cl, Br and OR³, wherein
R³ is selected from the group consisting of H, C₁-C₀ alkyl, C₃-C₁₀ cycloalkyl and C₂-C₁₅ alkenyl,
wherein the C₆-C₂₀-arylene is optionally interrupted by oxygen, sulfur, —NR—, —SO—, or —SO₂— and optionally substituted by —COOH or —SO₃H, or a mixture of such groups;
Z is a group of formula (IV)

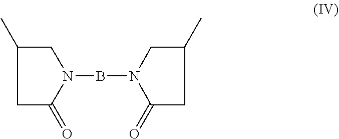

in which B is C₁-C₂₀-alkanediyl, which optionally is interrupted by one or more non-adjacent oxygen atoms, sulfur atoms or functional groups —NR— where the nitrogen atom is optionally protonated or quaternized, —CO—, —CO—O—, —CO—NR—, —SO— or —SO₂—, and optionally carries additional functional groups —COOH or —SO₃H, C₆-C₂₀-cycloalkanediyl or a mixture of such groups
or a mixture of the group of formula (IV) with groups A,
with an aqueous polymer dispersion, preferably comprising a (co)polymer selected from the group consisting of acrylic acid ester polymer, acrylic-styrene copolymer, styrene-butadiene-based copolymer, vinyl acetate polymer, and ethylene-vinyl acetate copolymer;
ii) spray drying the mixture obtained in step i).

In a preferred embodiment B1 of the second aspect, in step i) the pyrrolidone-containing polymer (PP) is mixed with the aqueous polymer dispersion in an amount of 4 to 20 wt.-%, preferably of 5 to 15 wt.-%, and in particular 6 to 12 wt.-%, based on the solid content of the aqueous polymer dispersion.

In a third aspect, the present invention relates to a re-dispersible dispersion powder (RDP) obtained by a process according to the second aspect.

In a fourth aspect, the present invention relates to a re-dispersible dispersion powder (RDP) comprising a (co)polymer selected from the group consisting of acrylic acid ester polymer, acrylic-styrene copolymer, styrene-butadiene-based copolymer, vinyl acetate polymer, and ethylene-vinyl acetate copolymer and a pyrrolidone-containing polymer (PP) comprising at least one unit of the general formulae (I) to (III)

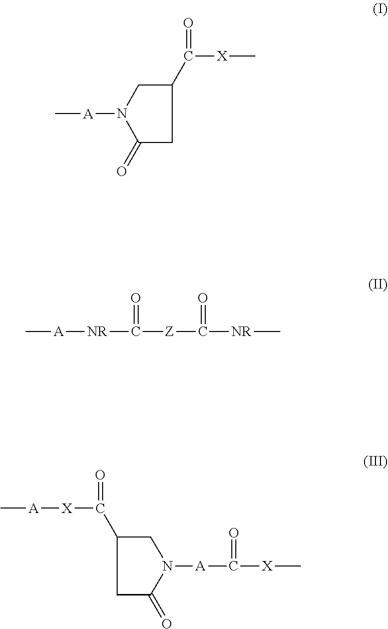

wherein R is independently hydrogen, C₁-C₄-alkyl, or two radicals R are linked to one another to form a six-membered ring;
X is —O— or —NR;
A is independently selected from the group consisting of C₁-C₂₀-alkanediyl, C₃-C₂O-cycloalkanediyl, and C₆-C₂₀-arylene,
wherein the C₁-C₂₀-alkanediyl is optionally interrupted by one or more non-adjacent oxygen atoms, sulfur atoms, or functional groups —NR— where the nitrogen atom is optionally protonated or quarternized, —CO—, —CO—O—, —CO—NR—, —SO—, or —SO₂—,
wherein the C₁-C₂₀-alkanediyl and the C₃-C₂₀-cycloalkanediyl optionally carry at least one functional group selected from the group consisting of C(═O)R² and SO₃H, wherein
R² is selected from the group consisting of Cl, Br and OR³, wherein
R³ is selected from the group consisting of H, C₁-C₀ alkyl, C₃-C₁₀ cycloalkyl and C₂-C₁₅ alkenyl,
wherein the C₆-C₂₀-arylene is optionally interrupted by oxygen, sulfur, —NR—, —SO—, or —SO₂— and optionally substituted by —COOH or —SO₃H, or a mixture of such groups;
Z is a group of formula (IV)

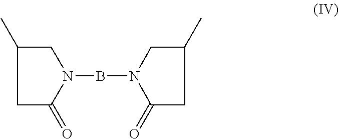

in which B is C₁-C₂₀-alkanediyl, which optionally is interrupted by one or more non-adjacent oxygen atoms, sulfur atoms or functional groups —NR—, where the nitrogen atom optionally is protonated or quaternized, —CO—, —CO—O—, —CO—NR—, —SO— or —SO₂—, and optionally carries additional functional groups —COOH or —SO₃H, C₆-C₂₀-cycloalkanediyl or a mixture of such groups
or a mixture of the group of formula (IV) with groups A.

In a fifth aspect, the present invention relates to a process of manufacturing a powder paint or a coating comprising blending the re-dispersible dispersion powder (RDP) according to the third or fourth aspect with a pigment.

In a sixth aspect, the present invention relates to a process of manufacturing a construction material composition comprising blending the re-dispersible dispersion powder (RDP) according to the third or fourth aspect with cement.

In a seventh aspect, the present invention relates to a pyrrolidone-containing polymer (PP) obtainable by polymerization of a reactive mixture (rM2), wherein the reactive mixture (rM2) comprises at least the following components:
(A) at least one itaconic acid derivative, and
(B) at least one amino acid of the general formula (1)

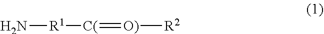

wherein
R¹ is selected from the group consisting of at least monosubstituted C₂-C₂₀-alkanediyl and at least monosubstituted C₃-C₂₀-cycloalkanediyl, wherein the substituent is NH₂;
R² is selected from the group consisting of Cl, Br and OR³, wherein
R³ is selected from the group consisting of H, C₁-C₁₀-alkyl, C₃-C₁₀-cycloalkyl and C₂-C₁₅-alkenyl.

In a preferred embodiment G1 of the seventh aspect, component (A) is selected from the group consisting of itaconic acid, itaconic anhydride, itaconic esters and itaconyl halides.

In a preferred embodiment G2 of the seventh aspect, component (B) is selected from the group consisting of L-Lysine, D-Lysine and racemic mixtures of L-Lysine and D-Lysine.

In an eighth aspect, the present invention relates to a process for producing a pyrrolidone-containing polymer (PP), wherein the process comprises polymerization of a reactive mixture (rM2), wherein the reactive mixture (rM2) comprises at least the following components
(A) at least one itaconic acid derivative, and
(B) at least one amino acid of the general formula (1)

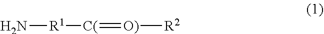

wherein
R¹ is selected from the group consisting of at least monosubstituted C₂-C₂₀ alkanediyl and at least monosubstituted C₃-C₂₀ cycloalkanediyl, wherein the substituent is NH₂;
R² is selected from the group consisting of Cl, Br and OR³, wherein
R³ is selected from the group consisting of H, C₁-C₁₀ alkyl, C₃-C₁₀ cycloalkyl and C₂-C₁₅ alkenyl.

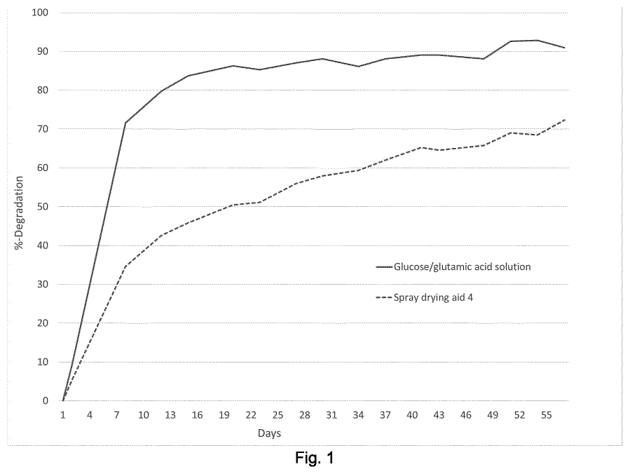

FIG. 1 depicts the biodegradability of spray drying aid 4 (SDA4).

### DETAILED DESCRIPTION

Before describing in detail exemplary embodiments of the present invention, definitions important for understanding the present invention are given.

As used in this specification and in the appended claims, the singular forms of “a” and “an” also include the respective plurals unless the context clearly dictates otherwise. In the context of the present invention, the terms “about” and “approximately” denote an interval of accuracy that a person skilled in the art will understand to still ensure the technical effect of the feature in question. The term typically indicates a deviation from the indicated numerical value of ±10%, preferably ±5%, more preferably ±2%, and in particular ±1%. It is to be understood that the term “comprising” is not limiting. For the purposes of the present invention the term “consisting of” is considered to be a preferred embodiment of the term “comprising of”. If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(a)”, “(b)”, “(c)”, “(d)”, “i”, “ii” etc. relate to steps of a method or use or assay there is no time or time interval coherence between the steps, i.e. the steps may be carried out simultaneously or there may be time intervals of seconds, minutes, hours, days, weeks, months or even years between such steps, unless otherwise indicated in the application as set forth herein above or below. It is to be understood that this invention is not limited to the particular methodology, protocols, reagents etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art.

The term “substituted”, as used herein, means that a hydrogen atom bonded to a designated atom is replaced with a specified substituent, provided that the substitution results in a stable or chemically feasible compound. Unless otherwise indicated, a substituted atom may have one or more substituents and each substituent is independently selected.

When neither the term “unsubstituted” nor “substituted” is explicitly mentioned concerning a moiety, said moiety is to be considered as unsubstituted.

The term “alkyl” as used herein denotes in each case a straight-chain or branched alkyl group having usually from 1 to 10 carbon atoms, preferably 1 to 5 or 1 to 4 carbon atoms, or 1 to 3 or 1 or 2 carbon atoms. Examples of an alkyl group are methyl, ethyl, n-propyl, iso-propyl, n-butyl, 2-butyl, iso-butyl, tert-butyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, and 1-ethyl-2-methylpropyl.

The term “alkanediyl” as used herein denotes in each case a hydrocarbon having e.g. 2 to 20 carbon atoms and two free valences. It is therefore a biradical having e.g. 2 to 20 carbon atoms.

The term “alkanediyl” encompasses both linear and branched, and also saturated and unsaturated, hydrocarbons having e.g. 2 to 20 carbon atoms and two free valences. Saturated hydrocarbons are preferred. Examples of C2-C20-alkanediyls are ethylene (ethane-1,2-diyl, dimethylene), propane-1,3-diyl (trimethylene), propylene (propane-1,2-diyl), and butane-1,4-diyl (tetramethylene). The alkanediyl group bridges a certain group to the remainder of the molecule.

The term “cycloalkanediyl” as used herein denotes in each case a cyclic hydrocarbon having e.g. 3 to 20 carbon atoms and two free valences. It is therefore a biradical having e.g. 3 to 20 carbon atoms. The term “cycloalkanediyl” encompasses both cyclic hydrocarbons and hydrocarbons having a cyclic fraction and a linear fraction having e.g. 3 to 20 carbon atoms and two free valences. Examples of C3-C20-cycloalkanediyls are cyclopropanediyl, cyclobutanediyl, cyclopentanediyl, cyclohexanediyl, cycloheptanediyl, cyclooctanediyl and cyclodecanediyl.

The term “arylene” as used herein denotes in each case a linking aromatic cyclic moiety having usually 6 to 20 carbon atoms, e.g. 6, 7, 8, 10 or 12, carbon atoms. The arylene group bridges a certain group to the remainder of the molecule. The arylene group can e.g. be phenylene. In this connection it is to be understood that aromatic means that the Hückel (4n+2) rule is fulfilled.

The term “cycloalkyl” as used herein denotes in each case a cyclic hydrocarbon radical with a carbon atom number from e.g. 3 to 10. The term “cycloalkyl” also encompasses hydrocarbons having a cyclic fraction and a linear fraction having e.g. 3 to 10 carbon atoms and one free valence. Examples of such cycloalkyl radicals are cyclopropyl, cyclobutyl, cyclopentyl, cyclohexyl, cycloheptyl, cyclooctyl and cyclodecyl.

The term “alkenyl” as used herein denotes in each case an unsaturated hydrocarbon group having usually 2 to 15, preferably 2 to 10 carbon atoms comprising at least one carbon-carbon double bond in any position, e.g. vinyl (ethenyl), allyl (2-propen-1-yl), 1-propen-1-yl, 2-propen-2-yl, methallyl (2-methylprop-2-en-1-yl), 2-buten-1-yl, 3-buten-1-yl, 2-penten-1-yl, 3-penten-1-yl, 4-penten-1-yl, 1-methylbut-2-en-1-yl, 2-ethylprop-2-en-1-yl, pentenyl, hexenyl and the like. If geometric isomers are possible with regard to the double bond, the present invention relates to both, the E- and Z-isomers. Preferred alkenyl groups according to the invention are terminal alkenyl groups. The bonding of vinyl is exemplified below:

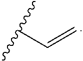 [SMILES: *C=C]

The organic moieties mentioned in the above definitions of the variables are collective terms for individual listings of the individual group members. The prefix Cₙ-Cₘ indicates in each case the possible number of carbon atoms in the group.

“At least one itaconic acid derivative”, as used in the context of the present invention, covers embodiments with exactly one itaconic acid derivative as well as those where mixture of two or more itaconic acid derivatives are used. The same applies to the use of “at least” in similar terms such as “at least one diamine”, “at least one amino acid”, “at least one (inorganic/organic) pigment”, “at least one re-dispersible dispersion powder”, “at least one (co)polymer”, “at least one filler”, “at least one dispersing agent”, “at least one thickener”, “at least one defoamer”, and the like.

The terms “component (A)” and “at least one itaconic acid derivative” are used synonymously in the context of the present invention and, therefore, possess the same meaning.

The same holds true for the terms “component (B)” and “at least one amino acid”. These terms are used synonymously in the context of the present invention, as well, and, therefore, possess the same meaning.

When referring to compositions and the weight percent of the therein comprised ingredients it is to be understood that according to the present invention the overall amount of ingredients does not exceed 100% (±1% due to rounding).

The term “particle” or “polymer particle” as used herein refers to polymeric fragment having a specific particle size Dx with regard to a specific particle size distribution, wherein x % of the particles have a diameter that is less than the Dx-value. The D₅₀ particle size is the median of the particle size distribution. The particle size distribution may e.g. be determined via dynamic light scattering (e.g. according to ISO 22412:2008). The particle size distribution may be indicated as volume distribution, surface distribution, or number distribution. Preferably, the Dx-value is the number distribution, wherein x % of the total number of the particles have a smaller diameter.

Preferred embodiments regarding the use of the SDA, of the process of manufacturing a re-dispersible dispersion powder (RDP), of the RDP, and of the method of manufacturing a powder paint or a coating, a construction material composition, a specific pyrrolidone-containing polymer (PP) and the process for producing the same are described hereinafter. It is to be understood that the preferred embodiments of the invention are encompassed by the scope of the invention individually as well as in all possible combinations with each other.

As indicated above, the present invention relates in one embodiment to a pyrrolidone-containing polymer (PP) comprising at least one unit of the general formulae (I) to (III)

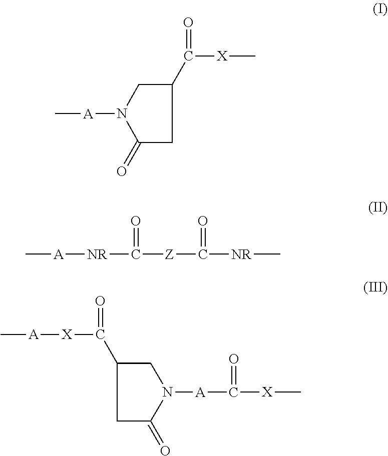

wherein R is independently hydrogen, C₁-C₄-alkyl, or two radicals R are linked to one another to form a six-membered ring;
X is —O— or —NR;
A is independently selected from the group consisting of C₁-C₂₀-alkanediyl, C₃-C₂O-cycloalkanediyl, and C₆-C₂₀-arylene,
wherein the C₁-C₂₀-alkanediyl is optionally interrupted by one or more non-adjacent oxygen atoms, sulfur atoms, or functional groups —NR— where the nitrogen atom is optionally protonated or quarternized, —CO—, —CO—O—, —CO—NR—, —SO—, or —SO₂—,
wherein the C₁-C₂₀-alkanediyl and the C₃-C₂₀-cycloalkanediyl optionally carry at least one functional group selected from the group consisting of C(═O)R² and SO₃H, wherein
R² is selected from the group consisting of Cl, Br and OR³, wherein
R³ is selected from the group consisting of H, C₁-C₁₀-alkyl, C₃-C₁₀-cycloalkyl and C₂-C₁₅-alkenyl,
wherein the C₆-C₂₀-arylene is optionally interrupted by oxygen, sulfur, —NR—, —SO—, or —SO₂— and optionally substituted by —COOH or —SO₃H, or a mixture of such groups;
Z is a group of formula (IV)

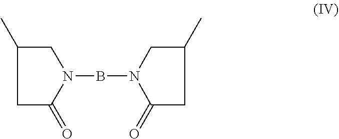

in which B is C₁-C₂₀-alkanediyl, which optionally is interrupted by one or more non-adjacent oxygen atoms, sulfur atoms or functional groups —NR— where the nitrogen atom is optionally protonated or quaternized, —CO—, —CO—O—, —CO—NR—, —SO— or —SO₂—, and optionally carries additional functional groups —COOH or —SO₃H, C₆-C₂₀-cycloalkanediyl or a mixture of such groups
or a mixture of the group of formula (IV) with groups A;
for use as spray drying aid for an aqueous polymer dispersion. In this aspect, the invention also relates to the use of said pyrrolidone-containing polymer (PP) as spray drying aid for an aqueous polymer dispersion.

In the following, preferred embodiments of the polymer and its use, which are relevant for all aspects of the invention, are described in further detail. It is to be understood that each preferred embodiment is intended to be covered individually as well as in in combination with any one or more of other preferred embodiments.

“Pyrrolidone-containing polymer (PP)” within the context of the present invention means that the polymer comprises pyrrolidonyl groups, preferably pyrrolidone groups as part of the polymer backbone (in contrast to pyrrolidone groups that are pendant groups only). The polymer may be a pyrrolidone-containing copolymer. In various embodiments, the term as used herein thus excludes polymers in which the pyrrolidone group is a pendant group, such as PVP. In various embodiments the polymer of the invention is thus not PVP. Pyrrolidonyl groups as part of the backbone may mean that they are bivalent repeating units of the polymer's backbone structure. Pyrrolidonyl groups are generally known to the skilled person. Pyrrolidonyl groups are groups which are derived from pyrrolidone by removing at least one hydrogen atom from any one of the ring atoms, thus generating a radical. Bivalent radical groups are explicitly covered by said term.

The pyrrolidone-containing polymers (PP) of the invention are advantageous over known PVP polymers in that they are more readily biodegradable and may be produced from renewable raw materials, such as itaconic acid and amino acids, in particular lysine. Further, they are easily soluble in water and aqueous solutions with high polymer concentrations are easily obtainable. A still further advantage is that the polymers of the invention can be synthesized as melts or solids and it is not necessary to carry out the reaction in solution. It has further been found that the claimed pyrrolidone-containing polymers (PP) are less sticky, less hygroscopic and more stable upon storage than common PVP polymers.

“Spray drying aid”, as used herein, relates to compounds that protect another compound or composition that is spray-dried from adverse effects that may occur upon drying and the exposure to elevated temperatures and pressures that are typical for commercial spray-drying processes. Such adverse effects include but are not limited to irreversible agglomeration and/or filming of the spray-dried compound or composition that impair its subsequent use and/or application, such as the re-dispersion in a liquid medium. Spray-drying aids achieve this by forming a protective shell or matrix that coats or embeds the spray-dried compound/composition during the spray-drying process. Spray-drying aids are thus functionally different from compounds used for solubilization or as protective colloids, as the latter are used for improving the solubility or dispersibility in liquid, typically aqueous media, while the former need to withstand the conditions during spray-drying and be able to protect other compounds from adverse effects of the spray-drying, for example by forming a protective shell around them or a protective matrix in which they are embedded. It is important to note that spray-drying aid thus function in a different way than solubilizers or protective colloids that are commonly unsuited to prevent formation of irreversible, insoluble and/or non-dispersible aggregates upon drying. In order to avoid that the polymers used as spray-drying aids are incorporated into the polymers of the aqueous polymer dispersion to be spray-dried, which may impair their functionality, they are typically not present during the generation of the polymer to be spray-dried but are added to the product polymer or a composition that contains said product polymer, such as the aqueous polymer dispersion referred to herein.

In a preferred embodiment, the pyrrolidone-containing polymer (PP) comprising at least one unit of the general formulae (I) to (II)

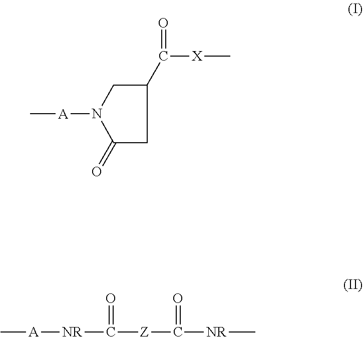

wherein R is independently hydrogen or C₁-C₂-alkyl;
X is —NR;
A is independently selected from the group consisting of C₁-C₂₀-alkanediyl, which optionally carries at least one functional group selected from the group consisting of C(═O)R² and SO₃H, wherein
R² is selected from the group consisting of Cl, Br and OR³, wherein
R³ is selected from the group consisting of H, C₁-C₁₀-alkyl, C₃-C₁₀-cycloalkyl and C₂-C₁₅-alkenyl;
Z is a group of formula (IV)

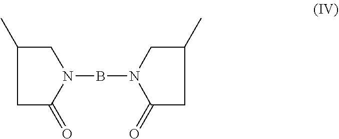

in which B is C₁-C₂₀-alkylene, which optionally carries additional functional groups —COOH or —SO₃H, or a mixture of the group of formula (IV) with groups A.

Preferably, A is C₁-C₂₀-alkanediyl, more preferably C₁-C₁₅-alkanediyl, and in particular C₁₋₁₀-alkanediyl. In some embodiments, A is C₁-, C₂-, C₃-, C₄-, C₅- or C₆-alkanediyl, preferably C₅ alkanediyl. The alkanediyl may preferably be linear and saturated. In various embodiments, it preferably carries one functional C(═O)R² group, optionally on the terminal carbon atom, e.g. the C₁ carbon atom. In such embodiments, the R² group is preferably OR³, with R³ preferably being H.

Preferably, B is C₁-C₁₅-alkanediyl, more preferably C₁-C₁₀-alkanediyl, and in particular C₁₋₈-alkanediyl. In some embodiments, B is C₁-, C₂-, C₃-, C₄-, C₅- or C₆-alkanediyl, preferably C₅-alkanediyl. The alkanediyl may preferably be linear and saturated. In various embodiments, it preferably carries one functional —COOH group, optionally on the terminal carbon atom, e.g. the C₁ carbon atom.

In a preferred embodiment, the pyrrolidone-containing polymer (PP) is obtainable by polymerization of a reactive mixture (rM1), wherein the reactive mixture (rM1) comprises at least the following components:
(A) at least one itaconic acid derivative, preferably wherein component (A) is selected from the group consisting of itaconic acid, itaconic anhydride, itaconic esters and itaconyl halides, and
(B) at least one diamine, preferably wherein the diamine is selected from the group consisting of ethylenediamine, 1,3-diaminopropane, 1,4-diaminobutane, 1,5-pentanediamine, 1,6-diaminohexane, 1,7-diaminoheptane, 1,8-diaminooctane, and 1,9-diaminononane, more preferably ethylenediamine and 1,5-pentanediamine.

In a preferred embodiment, the reactive mixture (rM1) comprises at least two diamines, preferably selected from the group consisting of ethylenediamine, 1,3-diaminopropane, 1,4-diaminobutane, 1,5-pentanediamine, 1,6-diaminohexane, and 1,7-diaminoheptane, and in particular wherein the reactive mixture (rM1) comprises ethylenediamine and 1,5-pentanediamine.

Preferably, the reactive mixture (rM1) comprises component (A) and the at least one diamine, preferably the sum of the at least two diamines, in a molar ratio of 10:1 to 1:10, preferably of 5:1 to 1:5, and in particular of 4:1 to 1:2 or 3:1 to 1:5.

In a preferred embodiment, the at least one itaconic acid derivative and the at least one diamine, preferably the sum of the at least two diamines, are present in the reactive mixture (rM1) in a molar ratio of 3:1 to 1:3, preferably of 2:1 to 1:2, and in particular of 1.5:1 to 1:1.5.

In a preferred embodiment, the reactive mixture (rM1) comprises in the range from 35 to 99 wt.-%, preferably from 40 to 90 wt.-%, more preferably from 50 to 75 wt.-%, of component (A) and in the range of 1 to 65 wt.-%, preferably from 10 to 60 wt.-%, more preferably from 25 to 50 wt.-%, of the at least one diamine, based on the sum of the percentages by weight of components (A) and the at least one diamine, preferably based on the total weight of the reactive mixture (rM1).

Unless otherwise indicated all of the percentages by weight of components (A) and the at least one amine as well as of optionally comprised solvent (S) such as water are based on the composition of the reactive mixture (rM1) before the beginning of the polymerization of the reactive mixture (rM1).

In this connection, the pyrrolidone-containing polymer (PP) preferably has a weight average molecular weight (Mw; determined by gel permeation chromatography (GPC) with 0.05 M aqueous ammonium formate/methanol mixture=80:20 (parts by volume) as eluent) of 500 to 100,000 g/mol, more preferably of 1,000 to 10,000 g/mol, still more preferably of 2,000 to 8,000 g/mol, and in particular of 3,000 to 6,000 g/mol. Preferably, the pyrrolidone-containing polymer (PP) has a number average molecular weight (Mn; determined by gel permeation chromatography (GPC) with 0.05 M aqueous ammonium formate/methanol mixture=80:20 (parts by volume) as eluent) of 500 to 20,000 g/mol, more preferably of 800 to 10,000 g/mol, still more preferably of 1,000 to 8,000 g/mol, and in particular of 1,000 to 4,000 g/mol.

In this connection, the determination of the molecular weight (Mass average molar mass (Mw) and number average molar mass (Mn)) of the polymers was generally performed as outlined in the experimental section in more detail.

Preferably, the pyrrolidone-containing polymer (PP) has a K-value (determined according to H. Fikentscher, Cellulose-Chemie 13, pages 48-64 und pages 71-94 (1932)) of 5 to 35, more preferably of 10 to 30, still more preferably of 14 to 25, and in particular of 15 to 22.

In a preferred embodiment, the reactive mixture (rM1) comprises water. The water comprising reaction mixture (rM1) is stirred and heated under reflux, preferably for 0.2 to 5 hours, more preferably for 0.5 to 3 hours, and in particular for 0.5 to 2 hours. After heating, the water is preferably removed via distillation. The distillation can be performed under normal pressure and by applying a vacuum.

In a preferred embodiment, the pyrrolidone-containing polymer (PP) is obtainable by polymerization of a reactive mixture (rM2), wherein the reactive mixture (rM2) comprises at least the following components:
(A) at least one itaconic acid derivative, preferably wherein component (A) is selected from the group consisting of itaconic acid, itaconic anhydride, itaconic esters and itaconyl halides, and
(B) at least one amino acid of the general formula (1)

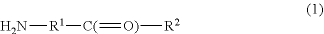

wherein
R¹ is selected from the group consisting of at least monosubstituted C₂-C₂₀ alkanediyl and at least monosubstituted C₃-C₂₀ cycloalkanediyl, wherein the substituent is NH₂;
R² is selected from the group consisting of Cl, Br and OR³, wherein
R³ is selected from the group consisting of H, C₁-C₁₀ alkyl, C₃-C₁₀ cycloalkyl and C₂-C₁₅ alkenyl.

Preferably,
R¹ is selected from the group consisting of at least monosubstituted C₂-C₂₀-alkanediyl, wherein the substituent is NH₂,
R² is selected from the group consisting of OH and Cl.

Particularly preferably,
R¹ is selected from the group consisting of monosubstituted C₃-C₁₀-alkanediyl, wherein the substituent is NH₂, for example linear and saturated C₄—, C₅—, or C₆—, preferably C₅-alkanediyl,
R² is OH.

In a preferred embodiment, component (B) is selected from the group consisting of L-Lysine, D-Lysine and racemic mixtures of L-Lysine and D-Lysine. It is particularly preferred that component (B) is L-Lysine.

In a preferred embodiment, the reactive mixture (rM2) comprises in the range from 0.5 to 70 wt.-%, preferably from 5 to 70 wt.-%, more preferably from 10 to 60 wt.-%, and in particular from 20 to 50 wt.-%, of component (A) and in the range of 30 to 99.5 wt.-%, preferably from 30 to 95 wt.-%, more preferably from 40 to 90 wt.-%, and in particular from 50 to 80 wt.-%, of the at least one component (B), based on the sum of the percentages by weight of components (A) and the at least one component (B), preferably based on the total weight of the reactive mixture (rM2).

In a preferred embodiment, the at least one itaconic acid derivative and the at least one amino acid of the general formula (1) are present in the reactive mixture (rM2) in a molar ratio of 10:1 to 1:10, preferably of 6:1 to 1:5 or of 5:1 to 1:5, and in particular of 4:1 to 1:2 or 3:1 to 1:5 or of 3:1 to 1:2.

Preferred is therefore a pyrrolidone-containing polymer (PP) wherein the molar ratio of component (A) to component (B) in the reactive mixture (rM2) is in the range from 3:1 to 1:2.

Furthermore preferred is a pyrrolidone-containing polymer (PP) wherein the molar ratio of component (A) to component (B) in the reactive mixture (rM2) is in the range from 3:1 to 1:10.

In this connection, the pyrrolidone-containing polymer (PP) preferably has a weight average molecular weight (Mw; determined by gel permeation chromatography (GPC) with 0.05 M aqueous ammonium formate/methanol mixture=80:20 (parts by volume) as eluent) of 500 to 100,000 g/mol, more preferably of 1,000 to 5,0000 g/mol, still more preferably of 1,000 to 10,000 g/mol, and in particular of 1,500 to 8,000 g/mol. Preferably, the pyrrolidone-containing polymer (PP) has a number average molecular weight (Mn; determined by gel permeation chromatography (GPC) as described above for Mw) of 500 to 20,000 g/mol, more preferably of 500 to 10,000 g/mol, still more preferably of 500 to 8,000 g/mol, and in particular of 1,000 to 6,000 g/mol. Preferably, the polydispersity (PD) of the pyrrolidone-containing polymer (PP) is in the range from 1.1 to 5, more preferably in the range 1.1 to 4 and most preferably in the range from 1.1 to 3. The polydispersity (PD) is the ratio between the weight average molar weight (Mw) and the number average molecular weight (Mn) of the pyrrolidone-containing polymer (PP). Preferably, the pyrrolidone-containing polymer (PP) has an amino number of 20 to 500 mg KOH/g, more preferably of 50 to 450 KOH/g, and in particular of 150 to 400 KOH/g, determined by titration. Suitable titration methods are known to the skilled person and are exemplarily described in further detail in the examples.

Unless indicated otherwise all of the wt.-% of components (A) and (B) as well as of an optionally comprised component (C) are based on the total weight of the composition of the reactive mixture (rM2) before the start of the polymerization reaction.

The phrase “composition of the reactive mixture (rM2) before the start of the polymerization”, as used in the context of the present invention, refers to the composition of the reactive mixture (rM2) before components (A) and (B) as well as optional component (C) present in the reactive mixture (rM2) start to react with each another, i.e. before the polymerization sets in and any reaction product is formed. Components (A) and (B) as well as optional component (C) present in the reactive mixture (rM2) are at that time point still in their unreacted form. It is understood that during the polymerization of components (A) and (B) as well as optional component (C) the components react at least partially with one another so that as a result the proportion of the components to each another changes.

As described above for the wt.-%, the “molar ratio” also relates to the molar ratio of component (A) to component (B) before the start of the polymerization reaction, and, therefore, before components (A) and (B) have reacted with one another.

The reactive mixture (rM2) may further comprise at least one catalyst as component (C).

“At least one catalyst”, as used in the context of the present invention, refers to one catalyst as well as a mixture of two or more catalysts.

The terms “component (C)” and “at least one catalyst” are used synonymously within the context of the present invention and, therefore, have the same meaning.

Suitable components (C) are catalysts which catalyze the reaction between components (A) and (B). Examples of suitable catalysts are phosphoric acid, alkali metal dihydrogen phosphates, alkali metal hypophosphites, alkali metal hydrogen sulfates, tin octanoates, titanium(IV)butoxide and bismuth-2,2-diphenylundecanoate.

Therefore, the reactive mixture (rM2) preferably additionally comprises component (C), i.e. at least one catalyst selected from the group consisting of phosphoric acid, alkali metal dihydrogen phosphates, alkali metal hypophosphites, alkali metal hydrogen sulfates, tin octanoates, titanium(IV)butoxide and bismuth-2,2-diphenylundecanoate.

Titanium(IV) butoxide is also referred to as Ti(OBu)4.

Alkali metal hypophosphites are preferred as component (C). Suitable alkali metal hypophosphites are known to the skilled person and are, for example and without limitation, selected from the group consisting of lithium hypophosphite, sodium hypophosphite and potassium hypophosphite. Sodium hypophosphite is particularly preferred as component (C).

For example, the reactive mixture (rM2) comprises component (C) in an amount in the range of from 0.1 to 5 wt.-%, preferably in the range of from 0.1 to 3 wt.-% and particularly preferably in the range of from 0.1 to 2 wt.-%, based on the sum of the percentages by weight of components (A), (B) and (C), preferably based on the total weight of the reactive mixture (rM2).

To the person skilled in the art it is apparent that the percentages by weight (wt.-%) of components (A) and (B) as well as optional component (C) usually add up to 100% by weight.

The polymerization of the reactive mixture (rM2) may be carried out in the presence of at least one solvent (S).

“At least one solvent (S)”, as used in the context of the present invention, includes use of one solvent (S) as well as a mixture of two or more solvents (S).

Suitable solvents (S) are known to the skilled person and are preferably solvents (S) which are inert towards the components comprised in the reactive mixture (rM2). Preferably, the at least one solvent (S) is selected from the group consisting of water, DMSO (dimethyl sulfoxide), NMP (N-methyl pyrrolidone), butyl acetate, methyl ethyl ketone and mixtures thereof. Preferably, the at least one solvent (S) is water.

In various embodiments, the polymerization of the reactive mixture (rM2) is carried out at temperatures in the range of from 50 to 300° C., preferably in the range of from 70 to 250° C. and particularly preferably in the range of from 90 to 240° C.

The polymerization can be carried out as a one step process or as a multi-step process. These processes are known to the person skilled in the art and are described in more detail below with respect to the process for producing the pyrrolidone-containing polymer (PP).

During the polymerization, components (A) and (B) undergo a polycondensation reaction to form the pyrrolidone-containing polymer (PP).

In a preferred embodiment, the pyrrolidone-containing polymer (PP) is biodegradable.

Preferably, the pyrrolidone-containing polymer (PP) has a biodegradability (determined according to OECD301F) of more than 20%, more preferably of more than 30%, still more preferably of more than 40%, and in particular of more than 45%, after 28 days. It is also preferred that the pyrrolidone-containing polymer (PP) has a biodegradability (determined according to OECD301F) of 20 to 100%, more preferably of 30 to 99%, still more preferably of 40 to 99% or of 40 to 90%, after 28 days.

Preferably the pyrrolidone-containing polymer (PP) comprises at least one unit of the general formula (A)

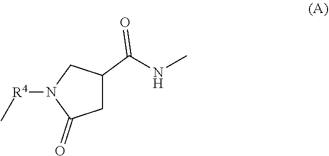

wherein
R⁴ is selected from the group consisting of at least monosubstituted C₂-C₂₀-alkanediyl and C₃-C₂₀-cycloalkanediyl, wherein at least one substituent is C(═O)R², wherein
R² is selected from the group consisting of Cl, Br and OR³, wherein
R³ is selected from the group consisting of H, C₁-C₁₀-alkyl, C₃-C₁₀-cycloalkyl and C₂-C₁₅-alkenyl.

R⁴ is preferably selected from the group consisting of at least monosubstituted C₂-C₂₀-alkanediyl, wherein at least one substituent is C(═O)R², wherein
R² is selected from the group consisting of OH and Cl.

R⁴ is most preferably selected from the group consisting of monosubstituted C₃-C₁₀-alkanediyl, wherein the substituent is C(═O)OH. In the above embodiments, R⁴ is preferably C₄-, C₅- or C₆-alkanediyl, preferably linear and saturated, most preferably linear and saturated C₅-alkanediyl.

In a preferred embodiment, the aqueous polymer dispersion comprises a (co)polymer selected from the group consisting of acrylic acid ester polymer, acrylic-styrene copolymer, styrene-butadiene-based copolymer, vinyl acetate polymer, and ethylene-vinyl acetate copolymer, preferably selected from the group consisting of acrylic-styrene copolymer, styrene-butadiene-based copolymer, and ethylene-vinyl acetate copolymer, more preferably acrylic-styrene copolymer.

The (co)polymer of the aqueous polymer dispersion is preferably made up of ethylenically unsaturated compounds in polymerized form. The preparation of these polyaddition compounds is generally carried out by metal complex-catalyzed, anionically catalyzed, cationically catalyzed and particularly preferably free-radically catalyzed polymerization, as is familiar to a person skilled in the art, of ethylenically unsaturated compounds.

The free-radically catalyzed polymerization of ethylenically unsaturated compounds is well-known to those skilled in the art and is, in particular, carried out by the method of free-radical bulk, emulsion, solution, precipitation, or suspension polymerization, with free-radically initiated aqueous emulsion polymerization being particularly preferred.

Carrying out free-radically initiated emulsion polymerization of ethylenically unsaturated compounds (monomers) in an aqueous medium is known [cf. Emulsion polymerization in Encyclopedia of Polymer Science and Engineering, Vol. 8, pages 659 ff. (1987); D. C. Blackley, in High Polymer Latices, Vol. 1, pages 35 ff. (1966); H. Warson, The Applications of Synthetic Resin Emulsions, chapter 5, pages 246 ff. (1972); D. Diederich, Chemie in unserer Zeit 24, pages 135 to 142 (1990); Emulsion Polymerisation, Interscience Publishers, New York (1965); DE-A 40 03 422 and Dispersionen synthetischer Hochpolymerer, F. Hölscher, Springer-Verlag, Berlin (1969)]. Free-radically initiated aqueous emulsion polymerization is usually carried out by dispersing the monomers, generally with concomitant use of dispersants such as emulsifiers and/or protective colloids, in an aqueous medium and polymerizing them by means of at least one water-soluble free-radical polymerization initiator. Frequently, the residual contents of unreacted monomers in the aqueous polymer dispersions obtained are decreased by chemical and/or physical after-treatment, the polymer solids content is set to a desired value by dilution or concentration or further customary additives, for example foam- or viscosity-modifying additives, are added to the aqueous polymer dispersion.

Possible monomers are, in particular, monomers which can be free-radically polymerized in a simple manner, for example ethylene, vinylaromatic monomers such as styrene, α-methylstyrene, or o-chlorostyrene, vinyl acetate, acrylic acid, esters of acrylic acid and methacrylic acid with alkanols, which generally have from 1 to 12, preferably from 1 to 8 and in particular from 1 to 4, carbon atoms, especially methyl, ethyl, n-butyl, isobutyl, pentyl, hexyl, heptyl, octyl, nonyl, decyl (e.g. hydroxyethyl methacrylate), esters of acrylic acid and methacrylic acid with alkanes, which generally have from 1 to 12, preferably from 1 to 10, and in particular from 1 to 8, carbon atoms (e.g. ethyl acrylate, butyl acrylate, 2-ethylhexyl acrylate, 2-propylheptyl acrylate), and 1,3-butadiene. When preparing a polymer dispersion, the monomers mentioned generally form the main monomers which, based on the amount of all ethylenically unsaturated compounds used for preparing the polymer dispersion (total amount of monomers), add up to a proportion of ≥50% by weight, preferably 80% by weight and particularly preferably ≥90% by weight. In general, these monomers have only a moderate to low solubility in water under standard conditions [20° C., 1 atm (=1.013 bar absolute)].

In a preferred embodiment, the aqueous polymer dispersion comprises an acrylic-styrene copolymer. Suitably, the acrylic-styrene copolymer is obtainable by free-radical polymerization of styrene and/or methylstyrene, in particular styrene, with acrylates selected from the group consisting of methyl acrylate, ethyl acrylate, butyl acrylate, 2-ethylhexyl acrylate, hydroxyethylmethacrylate, 2-propylheptyl acrylate, and mixtures thereof, in particular selected from the group consisting of 2-ethylhexyl acrylate, hydroxyethylmethacrylate, butyl acrylate, and mixtures thereof. In this connection, it is to be understood that methylstyrene generally refers to alpha-methylstyrene, beta-methylstyrene, 2-methylstyrene, 3-methylstyrene, and 4-methylstyrene, preferably to alpha-methylstyrene.

Preferably, the acrylic-styrene copolymer is obtainable by free-radical polymerization of 15 to 50 wt.-%, more preferably 20 to 45 wt.-%, and in particular 25 to 40 wt.-%, of styrene and/or methylstyrene with 50 to 85 wt.-%, more preferably 55 to 80 wt.-%, and in particular 60 to 75 wt.-%, of at least one acrylate. In this connection it is preferred that styrene is polymerized with the at least one acrylate selected from the group consisting of methyl acrylate, ethyl acrylate, butyl acrylate, 2-ethylhexyl acrylate, hydroxyethylmethacrylate, 2-propylheptyl acrylate, and mixtures thereof, in particular selected from the group consisting of 2-ethylhexyl acrylate, hydroxyethylmethacrylate, butyl acrylate, and mixtures thereof.

In a preferred embodiment, the aqueous polymer dispersion comprises a styrene-butadiene-based copolymer.

In a preferred embodiment, the aqueous polymer dispersion comprises a vinyl acetate polymer.

In a preferred embodiment, the aqueous polymer dispersion comprises a terpolymer. Suitable terpolymers are addition products of vinyl acetate, ethylene and vinyl ester. Preferably, the vinyl esters are those of carboxylic acids having 1 to 15 carbon atoms. Preference is given to vinyl acetate, vinyl propionate, vinyl butyrate, vinyl 2-ethylhexanoate, vinyl laurate, 1-methylvinyl acetate, vinyl pivalate, and vinyl esters of α-branched monocarboxylic acids having 9 to 11 carbon atoms, an example being commercially available polymers with the trade names VeoVa™ 9 or VeoVa™ 10. Vinyl acetate is particularly preferred.

In a preferred embodiment, the aqueous polymer dispersion has a solid polymer content, determined according to DIN EN ISO 3251, from 20 to 70 wt.-%, more preferably from 25 to 72 wt.-%, even more preferably from 30 to 65 wt.-%, and in particular from 50 to 62 wt.-% or of 45 to 55 wt.-% or of 52 to 62 wt.-%, based on the total weight of the aqueous polymer dispersion.

In a preferred embodiment, the aqueous polymer dispersion has a pH of 6 to 10, preferably of 7 to 9, and in particular of 7 to 8.

In a preferred embodiment, the (co)polymer of the aqueous polymer dispersion has a Tg (glass transition temperature), calculated using the Fox equation, of −60 to 35° C., preferably of −50 to 25° C., more preferably of −40 to 20° C., and in particular of −30 to 10° C. or of −25 to 0° C. or of −5 to 20° C. According to Fox (cf. T. G. Fox, Bull. Am. Phys. Soc. (Ser II) 1, 123, [1956] and Ullmanns Enzyklopädie der technischen Chemie, Weinheim (1980), S. 17, 18) the following equation is a suitable approximation for the Tg of polymer dispersions:

$$\frac{1}{{T}_{g}} = \frac{{X}^{1}}{{T}_{g}^{1}} + \frac{{X}^{2}}{{T}_{g}^{2}} + … \frac{{X}^{n}}{{T}_{g}^{n}}$$

wherein X¹, X², . . . , Xⁿ are the mass fractions 1, 2, . . . , n and Tg¹, Tg², . . . , Tgⁿ are the glass transition temperatures, in kelvins, of homopolymers of each of the monomers 1, 2, . . . , n. The individual Tgs are known, for example, from Ullmann's Encyclopedia of Industrial Chemistry, VCH, Weinheim, Vol. A 21 (1992) p. 169 and from J. Brandrup, E. H. Immergut, Polymer Handbook 3^{rd} ed., J. Wiley, New York 1989.

In a preferred embodiment, the minimum film forming temperature (MFFT; determined according to DIN ISO 2115) of the (co)polymer is of −20 to 20° C., preferably of −15 to 15° C., more preferably of −10 to 10° C., and in particular of −5 to 5° C.

In a preferred embodiment, the (co)polymer of the aqueous polymer dispersion has an average particle size (D 50 value) of the polymer particles as measured by dynamic light scattering (e.g. determined according to ISO 22412:2008) of 50 to 1000 nm, preferably of 100 to 900 nm, more preferably of 150 to 750 nm or of 700 to 900 nm.

The aqueous polymer dispersion may additionally comprise at least one surface active compound. The surface active compound serves to stabilize the aqueous dispersion of the polymer by keeping the particles of the polymer dispersed. The surface active compound may be an emulsifier, a protective colloid or a mixture of both of them. The emulsifier and the protective colloid typically differ from each other by their weight-average molar mass Mw. An emulsifier typically has a weight average molar mass Mw below 2000, while the weight-average molar mass Mw of a protective colloid may be up to 50 000, in particular from above 2000 to up to 50000. Typically, the amount of the surface active compound is in the range of from 0.1 to 10% by weight, in particular in the range of from 0.5 to 5% by weight, based on the total amount of polymer in the aqueous polymer dispersion.

Preferably, the surface active compound comprises one or more emulsifiers. The emulsifier is non-ionic, anionic, or cationic. In case of employing a mixture of emulsifiers, their compatibility has to be ensured, which can in case of doubt be evaluated by preliminary tests. Typically, an anionic emulsifier is compatible with another anionic emulsifier or a non-ionic emulsifier. Similarly, a cationic emulsifier is typically compatible with another cationic emulsifier or a non-ionic emulsifier. Preferably, the emulsifier is an anionic emulsifier, a combination of two or more anionic emulsifier or a combination of at least one anionic emulsifier and at least one non-ionic emulsifier. Non-ionic emulsifier are, for example, ethoxylated C₈-C₃₆ fatty alcohols having a degree of ethoxylation of from 3 to 50 (=ethylene oxide units [EO]: 3-50) and ethoxylated mono-, di- and tri-C₄-C₁₂ alkylphenols having a degree of ethoxylation of from 3 to 50. Examples of customary nonionic emulsifiers are the Eumulgin B grades (cetyl/stearyl alcohol ethoxylates, RTM BASF), Dehydol LS grades (fatty alcohol ethoxylates, EO units: 1-10, RTM BASF), Lutensol A grades (C₁₂C₁₄-fatty alcohol ethoxylates, EO units: 3-8, RTM BASF), Lutensol AO grades (C₁₃C₁₅-oxo alcohol ethoxylates, EO units: 3-30), Lutensol AT grades (C₁₆C₁₈-fatty alcohol ethoxylates, EO units: 11-80), Lutensol ON grades (C10-oxo alcohol ethoxylates, EO units: 3-11) and Lutensol TO grades (C₁₃-oxo alcohol ethoxylates, EO units: 3-20). Here and in the following the phrase “EO units” means the number average of ethylene oxide repeating units in the emulsifier. Anionic emulsifiers include for example the alkali metal salts of dialkyl esters of sulfosuccinic acid, the alkali metal salts and the ammonium salt of C₈-C₁₂ alkyl sulfates, the alkali metal salts and the ammonium salts of C₁₂-C₁₈ alkylsulfonic acids, the alkali metal salts and the ammonium salts of C₉-C₁₈ alkylarylsulfonic acid, the alkali metal salts and the ammonium salts of sulfuric acid monoesters of ethoxylated C₁₂-C₁₈ alkanols (EO units: 4-30) or a sulfuric acid monoester of an ethoxylated (C₄-C₁₂ alkyl)phenol (EO units: 3-50).

Further suitable anionic emulsifiers include, without limitation, fatty alcohol phosphates, alkylphenol phosphates, alkyl polyglycol ether phosphates, alkyl polyalkylene oxide phosphates, and fatty alcohol ether phosphates and the salts thereof, in particular the alkali metal salts and ammonium salts thereof, with particular preference given to the alkali metal salts, such as sodium salts.

A comprehensive description of suitable emulsifiers may be found in Houben-Weyl, Methoden der organischen Chemie, volume XIV/1, Makromolekulare Stoffe, Georg-Thieme-Verlag, Stuttgart, 1961, pages 192 to 208.

Similar to the aforementioned emulsifiers, suitable protective colloids may be non-ionic, anionic or cationic. Examples of protective colloids are poly(vinyl alcohols), poly(alkylene glycols), poly(acrylic acids) and the alkali metal salt thereof, poly(methacrylic acids) and the alkali metal salt thereof and gelatin derivatives. Anionic protective colloid can also be a copolymer, containing a suitable amount of at least one anionic monomer, such as acrylic acid, methacrylic acid, maleic acid, 2-acrylamido-2-methylpropane sulfonic acid, para-vinylphenyl sulfonic acid or salt forms thereof, preferably alkali metal salts thereof, in polymerized form. Examples of cationic protective colloids are homo polymers and copolymers containing a sufficient amount of cationic monomers, in particular monoethylenically unsaturated monomers having one or more amino groups, which are N-protonated or N-alkylated.

The protective colloids are distinct from the polymers dispersed in the aqueous polymer dispersion as they are water-soluble or water dispersible. The term “water-soluble or water dispersible” is understood that the corresponding protective colloid can be dissolved or dispersed in deionized water at 20° C. and 1013 mbar in an amount of at least 10 g/L polymer, preferably such that the resulting aqueous solution has either no measurable particles or particles of a size of at most 20 nm as determined by dynamic light scattering in accordance with DIN 22412:2008.

A comprehensive description of suitable protective colloids may be found in Houben-Weyl, Methoden der organischen Chemie, volume XIV/1, Makromolekulare Stoffe, Georg-Thieme-Verlag, Stuttgart, 1961, pages 411 to 420.

As indicated above, the present invention further relates in a second aspect to a process of manufacturing a re-dispersible dispersion powder (RDP), the process comprising the steps of
i) mixing a pyrrolidone-containing polymer (PP) comprising at least one unit of the general formulae (I) to (III)

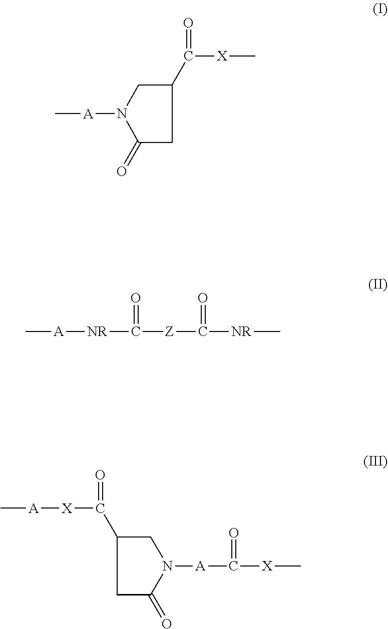

wherein R is independently hydrogen, C₁-C₄-alkyl, or two radicals R are linked to one another to form a six-membered ring;
X is —O— or —NR;
A is independently selected from the group consisting of C₁-C₂₀-alkanediyl, C₃-C₂₀-cycloalkanediyl, and C₆-C₂₀-arylene,
wherein the C₁-C₂₀-alkanediyl is optionally interrupted by one or more non-adjacent oxygen atoms, sulfur atoms, or functional groups —NR— where the nitrogen atom is optionally protonated or quarternized, —CO—, —CO—O—, —CO—NR—, —SO—, or —SO₂—,
wherein the C₁-C₂₀-alkanediyl and the C₃-C₂₀-cycloalkanediyl optionally carry at least one functional group selected from the group consisting of C(═O)R² and SO₃H, wherein
R² is selected from the group consisting of Cl, Br and OR³, wherein
R³ is selected from the group consisting of H, C₁-C₁₀ alkyl, C₃-C₁₀ cycloalkyl and C₂-C₁₅ alkenyl,
wherein the C₆-C₂₀-arylene is optionally interrupted by oxygen, sulfur, —NR—, —SO—, or —SO₂— and optionally substituted by —COOH or —SO₃H, or a mixture of such groups;
Z is a group of formula (IV)

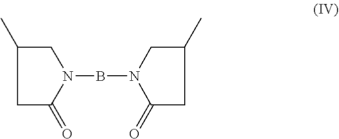

in which B is C₁-C₂₀-alkanediyl, which optionally is interrupted by one or more non-adjacent oxygen atoms, sulfur atoms or functional groups —NR— where the nitrogen atom is optionally protonated or quaternized, —CO—, —CO—O—, —CO—NR—, —SO— or —SO₂—, and optionally carries additional functional groups —COOH or —SO₃H, C₆-C₂₀-cycloalkanediyl or a mixture of such groups
or a mixture of the group of formula (IV) with groups A
with an aqueous polymer dispersion, preferably comprising a (co)polymer selected from the group consisting of acrylic acid ester polymer, acrylic-styrene copolymer, styrene-butadiene-based copolymer, vinyl acetate polymer, and ethylene-vinyl acetate copolymer;
ii) spray drying the mixture obtained in step i).

Preferred embodiments (e.g. regarding the pyrrolidone-containing polymer (PP), the aqueous polymer dispersion, and the ingredient's amounts) are already disclosed above in relation to the pyrrolidone-containing polymer (PP) as well as its as spray drying aid and similarly apply to the process of manufacturing an RDP. This particularly applies to the preferred definitions of A and B. Particularly preferred embodiments of the process are disclosed (again) in the following.

In a preferred embodiment, the pyrrolidone-containing polymer (PP) is obtainable by polymerization of a reactive mixture (rM1), wherein the reactive mixture (rM1) comprises at least the following components:
(A) at least one itaconic acid derivative, preferably wherein component (A) is selected from the group consisting of itaconic acid, itaconic anhydride, itaconic esters and itaconyl halides, and
(B) at least one diamine, preferably wherein the diamine is selected from the group consisting of ethylenediamine, 1,3-diaminopropane, 1,4-diaminobutane, 1,5-pentanediamine, 1,6-diaminohexane, 1,7-diaminoheptane, 1,8-diaminooctane, and 1,9-diaminononane, more preferably ethylenediamine and 1,5-pentanediamine.

In a preferred embodiment, the reactive mixture (rM1) comprises at least two diamines, preferably selected from the group consisting of ethylenediamine, 1,3-diaminopropane, 1,4-diaminobutane, 1,5-pentanediamine, 1,6-diaminohexane, and 1,7-diaminoheptane, and in particular wherein the reactive mixture (rM1) comprises ethylenediamine and 1,5-pentanediamine.

In a preferred embodiment, the pyrrolidone-containing polymer (PP) is obtainable by polymerization of a reactive mixture (rM2), wherein the reactive mixture (rM2) comprises at least the following components:
(A) at least one itaconic acid derivative, preferably wherein component (A) is selected from the group consisting of itaconic acid, itaconic anhydride, itaconic esters and itaconyl halides, and
(B) at least one amino acid of the general formula (1)

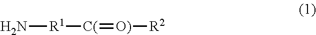

wherein
R¹ is selected from the group consisting of at least monosubstituted C₂-C₂₀-alkanediyl and at least monosubstituted C₃-C₂₀-cycloalkanediyl, wherein the substituent is NH₂, for example linear and saturated C₄—, C₅—, or C₆—, preferably C₅-alkanediyl;
R² is selected from the group consisting of Cl, Br and OR³, wherein
R³ is selected from the group consisting of H, C₁-C₀ alkyl, C₃-C₁₀ cycloalkyl and C₂-C₁₅ alkenyl, preferably wherein component (B) is selected from the group consisting of L-Lysine, D-Lysine and racemic mixtures of L-Lysine and D-Lysine.

In a preferred embodiment, in step i) the pyrrolidone-containing polymer (PP) is mixed with the aqueous polymer dispersion in an amount of 4 to 20 wt.-%, preferably of 5 to 15 wt.-%, and in particular 6 to 12 wt.-%, based on the solid content of the aqueous polymer dispersion.

Any suitable apparatus may be used in step ii).

In a preferred embodiment, the aqueous dispersion is sprayed through a two-fluid nozzle.

In a preferred embodiment, the inlet temperature of the dryer gas is of 100 to 200° C., preferably of 105 to 190° C., more preferably of 110 to 180° C., and in particular of 115 to 160° C.

In a preferred embodiment, the outlet temperature of the dryer gas is of 40 to 90° C., preferably of 45 to 85° C., more preferably of 50 to 80° C., and in particular of 55 to 75° C.

As indicated above, the present invention further relates in a third aspect to a re-dispersible dispersion powder (RDP) obtained by the above-outlined process of manufacturing a re-dispersible dispersion powder (RDP).

Preferred embodiments (e.g. regarding the pyrrolidone-containing polymer (PP), the aqueous polymer dispersion, the ingredient's amounts, and the process of manufacturing the RDP) have been disclosed above in relation to the pyrrolidone-containing polymer (PP) as well as its use as spray drying aid and the process of manufacturing an RDP and similarly apply to the RDP, as well.

As indicated above, the present invention further relates in a fourth aspect to a re-dispersible dispersion powder (RDP) comprising a (co)polymer selected from the group consisting of acrylic acid ester polymer, acrylic-styrene copolymer, styrene-butadiene-based copolymer, vinyl acetate polymer, and ethylene-vinyl acetate copolymer and a pyrrolidone-containing polymer (PP) comprising at least one unit of the general formulae (I) to (III)

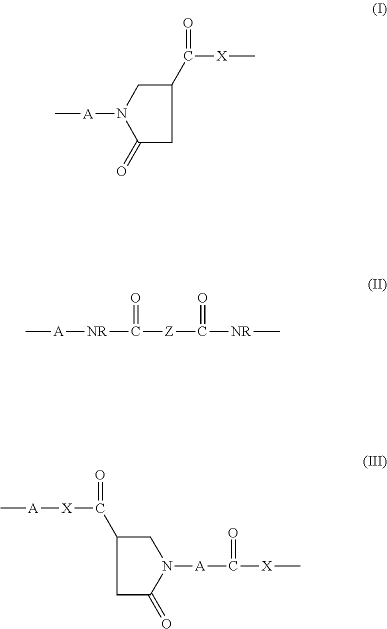

wherein R is independently hydrogen, C₁-C₄-alkyl, or two radicals R are linked to one another to form a six-membered ring;
X is —O— or —NR;
A is independently selected from the group consisting of C₁-C₂₀-alkanediyl, C₃-C₂O-cycloalkanediyl, and C₆-C₂₀-arylene,
wherein the C₁-C₂₀-alkanediyl is optionally interrupted by one or more non-adjacent oxygen atoms, sulfur atoms, or functional groups —NR— where the nitrogen atom is optionally protonated or quarternized, —CO—, —CO—O—, —CO—NR—, —SO—, or —SO₂—,
wherein the C₁-C₂₀-alkanediyl and the C₃-C₂₀-cycloalkanediyl optionally carry at least one functional group selected from the group consisting of C(═O)R² and SO₃H, wherein
R² is selected from the group consisting of Cl, Br and OR³, wherein
R³ is selected from the group consisting of H, C₁-C₀ alkyl, C₃-C₁₀ cycloalkyl and C₂-C₁₅ alkenyl,
wherein the C₆-C₂₀-arylene is optionally interrupted by oxygen, sulfur, —NR—, —SO—, or —SO₂— and
optionally substituted by —COOH or —SO₃H, or a mixture of such groups;
Z is a group of formula (IV)

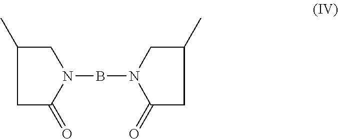

in which B is C₁-C₂₀-alkanediyl, which optionally is interrupted by one or more non-adjacent oxygen atoms, sulfur atoms or functional groups —NR—, where the nitrogen atom optionally is protonated or quaternized, —CO—, —CO—O—, —CO—NR—, —SO— or —SO₂—, and optionally carries additional functional groups —COOH or —SO₃H, C₆-C₂₀-cycloalkanediyl or a mixture of such groups
or a mixture of the group of formula (IV) with groups A.

In a preferred embodiment, the pyrrolidone-containing polymer (PP) is obtainable by polymerization of a reactive mixture (rM1), wherein the reactive mixture (rM1) comprises at least the following components:
(A) at least one itaconic acid derivative, preferably wherein component (A) is selected from the group consisting of itaconic acid, itaconic anhydride, itaconic esters and itaconyl halides, and
(B) at least one diamine, preferably wherein the diamine is selected from the group consisting of ethylenediamine, 1,3-diaminopropane, 1,4-diaminobutane, 1,5-pentanediamine, 1,6-diaminohexane, 1,7-diaminoheptane, 1,8-diaminooctane, and 1,9-diaminononane, more preferably ethylenediamine and 1,5-pentanediamine.

In a preferred embodiment, the reactive mixture (rM1) comprises at least two diamines, preferably selected from the group consisting of ethylenediamine, 1,3-diaminopropane, 1,4-diaminobutane, 1,5-pentanediamine, 1,6-diaminohexane, and 1,7-diaminoheptane, and in particular wherein the reactive mixture (rM1) comprises ethylenediamine and 1,5-pentanediamine.

In a preferred embodiment, the pyrrolidone-containing polymer (PP) is obtainable by polymerization of a reactive mixture (rM2), wherein the reactive mixture (rM2) comprises at least the following components:
(A) at least one itaconic acid derivative, preferably wherein component (A) is selected from the group consisting of itaconic acid, itaconic anhydride, itaconic esters and itaconyl halides, and
(B) at least one amino acid of the general formula (1)

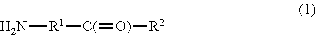

wherein
R¹ is selected from the group consisting of at least monosubstituted C₂-C₂₀-alkanediyl and at least monosubstituted C₃-C₂₀-cycloalkanediyl, wherein the substituent is NH₂, for example linear and saturated C₄-, C₅-, or C₆-, preferably C₅-alkanediyl;
R² is selected from the group consisting of Cl, Br and OR³, wherein
R³ is selected from the group consisting of H, C₁-C₁₀ alkyl, C₃-C₁₀ cycloalkyl and C₂-C₁₅ alkenyl, preferably wherein component (B) is selected from the group consisting of L-Lysine, D-Lysine and racemic mixtures of L-Lysine and D-Lysine.

As indicated above, the present invention further relates in a fifth aspect to a process of manufacturing a powder paint or a coating comprising blending the above-outlined re-dispersible dispersion powder (RDP) with a pigment.

Preferred embodiments (e.g. regarding the pyrrolidone-containing polymer (PP), the aqueous polymer dispersion, and the ingredient's amounts) are already above-outlined in the use of the pyrrolidone-containing polymer (PP) as spray drying aid as well as in the process of manufacturing an RDP and shall apply for the powder paint or the coating, as well. Particularly preferred embodiment are mentioned in the following.

In a preferred embodiment, the powder paint comprises at least one inorganic pigment and/or at least one organic pigment. These may be selected from those disclosed below.

Preferably, the powder paint comprises an inorganic white pigment, more preferably selected from the group consisting of titanium dioxide, preferably in the rutile form, barium sulfate, zinc oxide, zinc sulfide, basic lead carbonate, antimony trioxide, and lithopone (zinc sulfide and barium sulfate) or an inorganic colored pigment, more preferably selected from the group consisting iron oxides, carbon black, graphite, zinc yellow, zinc green, ultramarine, manganese black, antimony black, manganese violet, Prussian blue and Parisian green, in particular titanium dioxide.

Preferably, the powder paint comprises an organic pigment. Suitable organic color pigments are, for example sepia, gamboge, Cassel brown, toluidine red, para red, Hansa yellow, indigo, azo dyes, anthraquinonoid and indigoid dyes and also dioxazine, quinacridone, phthalocyanine, isoindolinone and metal-complex pigments. Also useful are the Luconyl® brands from BASF SE, e.g., Luconyl® yellow, Luconyl® brown and Luconyl® red, especially the transparent versions. In a preferred embodiment, the powered paint comprises an organic pigment, wherein the organic pigment is in the form of hollow organic particles and/or is based on polymers, comprising nonionic ethylenically unsaturated monomers, preferably wherein the nonionic ethylenically unsaturated monomer is selected from the group consisting of styrene, acrylonitrile, methacrylamide, methyl methacrylate, ethyl acrylate, ethyl methacrylate, butyl acrylate, butyl methacrylate, 2-ethylhexyl acrylate, 2-ethylhexyl methacrylate, or mixtures thereof.

The paints or coatings of the invention are produced in a known manner by blending the components in customary mixers. A tried and tested procedure is to first prepare an aqueous paste or dispersion from the pigments, water and optionally auxiliaries and then to mix the polymeric binder, i.e., typically an aqueous dispersion of the polymer, with the pigment paste and the pigment dispersion, respectively.

The paint or coating of the invention can be applied to substrates in a conventional manner, e.g., by brushing, spraying, dipping, rolling or knifecoating.

In a preferred embodiment, the process comprises blending
a) 8 to 20 wt.-% of at least one pigment with
b) 10 to 19 wt.-% of at least one re-dispersible dispersion powder (RDP) comprising
i) at least one (co)polymer selected from the group consisting of acrylic acid ester polymer, acrylic-styrene copolymer, styrene-butadiene-based copolymer, vinyl acetate polymer, and ethylene-vinyl acetate copolymer, preferably acrylic-styrene copolymer, and
ii) at least one pyrrolidone-containing polymer (PP),
c) 55 to 78 wt.-% of at least one filler,
d) 0.2 to 2 wt.-% of at least one dispersing agent,
d) 0.5 to 2 wt.-% of at least one thickener, and
e) 0.5 to 2 wt.-% of at least one defoamer,
each based on the total dry weight of the powder paint.

Powder paints obtained via the above-described process are particularly suitable as interior paints.

In a preferred embodiment, the process comprises blending
a) 21 to 30 wt.-% of at least one pigment,
b) 15 to 25 wt.-% of at least one re-dispersible dispersion powder (RDP) comprising
i) at least one (co)polymer selected from the group consisting of acrylic acid ester polymer, acrylic-styrene copolymer, styrene-butadiene-based copolymer, vinyl acetate polymer, and ethylene-vinyl acetate copolymer, preferably acrylic-styrene copolymer, and
ii) at least one pyrrolidone-containing polymer (PP),
c) 40 to 54 wt.-% of at least one filler,
d) 0.2 to 2 wt.-% of at least one dispersing agent,
d) 0.5 to 2 wt.-% of at least one thickener, and
e) 0.5 to 2 wt.-% of at least one defoamer,
each based on the total dry weight of the powder paint.

Powder paints obtained via the above-described process are particularly suitable as exterior paints.

In a preferred embodiment, the process comprises blending
b) 2 to 30 wt.-% of at least one pigment with
b) 10 to 25 wt.-% of at least one re-dispersible dispersion powder (RDP) comprising
i) at least one (co)polymer selected from the group consisting of acrylic acid ester polymer, acrylic-styrene copolymer, styrene-butadiene-based copolymer, vinyl acetate polymer, and ethylene-vinyl acetate copolymer, preferably acrylic-styrene copolymer, and
ii) at least one pyrrolidone-containing polymer (PP),
c) 40 to 78 wt.-% of at least one filler,
d) 0.2 to 2 wt.-% of at least one dispersing agent,
d) 0.5 to 2 wt.-% of at least one thickener, and
e) 0.5 to 2 wt.-% of at least one defoamer,
each based on the total dry weight of the coating.

Suitable fillers include, for example, matting agents to substantially reduce gloss in a desired manner. Matting agents are generally transparent and may be not only organic but also inorganic. Inorganic fillers based on silica are most suitable and are widely available commercially. Examples are the Syloid® brands of W.R. Grace & Company and the Acematt® brands of Evonik Industries AG. Organic matting agents are for example available from BYK-Chemie GmbH under the Ceraflour® and the Ceramat® brands, from Deuteron GmbH under the Deuteron MK® brand. Suitable fillers for emulsion paints further include aluminosilicates, such as feldspars, silicates, such as kaolin, talc, mica, magnesite, alkaline earth metal carbonates, such as calcium carbonate, for example in the form of calcite or chalk, magnesium carbonate, dolomite, alkaline earth metal sulfates, such as calcium sulfate, silicon dioxide, etc. The preference in paints is naturally for finely divided fillers. The fillers can be used as individual components. In practice, however, filler mixtures have been found to be particularly advantageous, examples being calcium carbonate/kaolin and calcium carbonate/talc. Gloss paints generally include only minimal amounts of very finely divided fillers or contain no fillers at all.

Finely divided fillers can also be used to enhance the opacity and/or to economize on white pigments. Blends of fillers and color pigments are preferably used to control the opacity of the hue/color and of the depth of shade (color strength).

In a preferred embodiment, the at least one filler is selected from the group consisting of calcium carbonate, precipitated calcium carbonate, talc, mica, silica, alumina silicate, nepheline syenite, clay, calcinated clay, feldspar, and mixtures thereof.

Suitable dispersing agents are, for example, sodium polyphosphates, potassium polyphosphates, ammonium polyphosphates, alkali metal and ammonium salts of (meth)acrylic acid copolymers or of maleic anhydride copolymers, polyphosphonates, such as sodium 1-hydroxyethane-1,1-diphosphonate, and also naphthalenesulfonic acid salts, in particular their sodium salts. In a preferred embodiment, the at least one dispersing agent is a sodium salt of a carboxylic acid copolymer in water or a copolymer of maleic acid and an olefin as the sodium salt, preferably a sodium salt of a carboxylic acid copolymer in water. Dispersing agents may be present in the powder paint in an amount of 0.1 to 2 wt %, preferably of 0.2 to 1 wt %, based on the total amount of the formulation. Preferably, the amount is adjusted to the used fillers.

Suitable defoamer are, for example, hydrophobic materials such as silicones, polysiloxanes, mineral oil, plant oil, and white oil, which are often offered in powder form in combination with surface-active substances (e.g. FoamStar PB 2922) and are typically bonded to a carrier substance such as silica (e.g. Agitan P 804).

In a preferred embodiment, the at least one defoamer is a modified polysiloxane.

Useful thickeners include, for example, associative thickeners, such as polyurethane thickeners. The amount of thickener is preferably less than 2.5 wt %, more preferably less than 1.5 wt % of thickener, based on paint solids content. Further directions regarding the formulation of wood paints are described at length in “Water based acrylates for decorative coatings” by the authors M. Schwartz and R. Baumstark, ISBN 3-87870-726-6. Further suitable thickeners include, for example, acrylic thickener, cellulose ether, chemical modified cellulose derivatives (cellulosics—hydroxyethyl cellulose (HEC), carboxymethyl celluloses (CMC), hydroxypropyl methylcellulose, methylcellulose, hydroxypropyl cellulose, ethylhydroxyethyl cellulose, and others—chemically substituted cellulose macromolecules), hydrophobic modified polyether (HMPE), gums, saccharides, polysaccharides, and polyvinyl alcohol.

In a preferred embodiment, the at least one thickener is a hydroxyethylcellulose (HEC), preferably having a weight average molecular weight (Mw; determined by gel permeation chromatography (GPC) with 0.05 M aqueous ammonium formate/methanol mixture=80:20 (parts by volume) as eluent) of 1,000 to 100,000 g/mol, more preferably of 5,000 to 60,000 g/mol, still more preferably of 10,000 to 50,000 g/mol, and in particular of 15,000 to 25,000 g/mol.

Film-forming agents may further be blended into the powder paints. Suitable film-forming assistants include, for example and without limitation, Texanol® from Eastman Chemicals and glycol ethers and esters, such as those commercially available, for example, from BASF SE, under the trade names Solvenon® and Lusolvan®, and from Dow Chemicals under the trade name Dowanol®. The amount is preferably <10 wt % and more preferably <5 wt %, based on overall formulation. It is also possible to formulate entirely without solvents and/or film-forming agents.

Wetting agents may further be included and blended. Suitable wetting agents include, for example, non-ionic surfactants such as non-ionic, ethoxylated fatty alcohol-based surfactant or non-ionic, propoxylated fatty alcohol-based surfactant (e.g. Lumiten N-OG). Wetting agents may be present in the powder paint in an amount of 0.1 to 2 wt %, preferably of 0.2 to 1 wt %, based on the total amount of the formulation. Preferably, the amount is adjusted to the used fillers.

Further information on paint formulations can be found in the textbooks “Additives for Water-borne Coatings” from Wernfried Heilen et al.; Vincentz-Verlag 2021; 978-3-7486-0486-0 (ISBN) and in “Waterbased Acrylates for Decorative Coatings” from Manfred Schwartz, Roland Baumstark; Vincentz Press, 2001 in chapter 2).

As indicated above, the present invention further relates in a sixth aspect to a process of manufacturing a construction material composition comprising blending the above-outlined re-dispersible dispersion powder (RDP) with cement.

All preferred embodiments Disclosed above in relation to other aspects of the invention, similarly apply to this particular aspect.

The term “cement” as used herein encompasses concrete and mortar.

The term “concrete” denotes a mortar to which are added coarse granulates, i.e. granulates with a diameter of greater than 5 mm. The term “mortar” or “grout” denotes a cement paste to which are added fine granulates, i.e. granulates whose diameter is between 150 pm and 5 mm (for example sand), and optionally very fine granulates. A grout is a mixture of sufficiently low viscosity for filling in voids or gaps. Mortar viscosity is high enough to support not only the mortar's own weight but also that of masonry placed above it. The term “cement paste” denotes the inorganic binder composition admixed with water.

The aggregate in this invention can be for example silica, quartz, sand, crushed marble, glass spheres, granite, limestone, sandstone, calcite, marble, serpentine, travertine, dolomite, feldspar, gneiss, alluvial sands, any other durable aggregate, and mixtures thereof. The aggregates are often also called fillers and in particular do not work as a binder.

Suitable inorganic binder are selected from the group consisting of a hydraulic binder, a latent hydraulic binder, a binder based on calcium sulfate, and mixtures thereof.

As indicated above, the present invention further relates in a seventh aspect to a pyrrolidone-containing polymer (PP) obtainable by polymerization of a reactive mixture (rM2), wherein the reactive mixture (rM2) comprises at least the following components:
(A) at least one itaconic acid derivative, and
(B) at least one amino acid of the general formula (1)

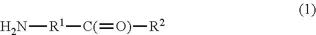

wherein
R¹ is selected from the group consisting of at least monosubstituted C₂-C₂₀-alkanediyl and at least monosubstituted C₃-C₂₀-cycloalkanediyl, wherein the substituent is NH₂;
R² is selected from the group consisting of Cl, Br and OR³, wherein
R³ is selected from the group consisting of H, C₁-C₁₀-alkyl, C₃-C₁₀-cycloalkyl and C₂-C₁₅-alkenyl.

In various embodiments, R¹ is a linear and saturated monosubstituted C₃-C₆ alkanediyl, in particular C₄, C₅ or C₆, preferably C₅-alkanediyl, with the NH₂ substituent being located on the most distal carbon atom. Preferably, the amino acid is D- or L-lysine, more preferably L-lysine.

Preferred embodiments (e.g. regarding component (A) and component (B)) have already been disclosed above in relation to the pyrrolidone-containing polymer (PP) and its use as spray drying aid as well as in the process of manufacturing an RDP and similarly apply to the pyrrolidone-containing polymer (PP). Particularly preferred embodiment are mentioned in the following.

For example, the reactive mixture (rM2) comprises in the range from 0.5 to 70% by weight of component (A) and in the range from 30 to 99.5% by weight of component (B), based on the sum of the percentages by weight of components (A) and (B). In a preferred embodiment, the reactive mixture (rM2) comprises in the range from 0.5 to 70% by weight of component (A) and in the range from 30 to 99.5% by weight of component (B) based on the total weight of the reactive mixture (rM2).

Preferably the reactive mixture (rM2) comprises in the range from 5 to 70% by weight of component (A) and in the range from 30 to 95% by weight of component (B) based on the sum of the percentages by weight of components (A) and (B), preferably based on the total weight of the reactive mixture (rM2).

Particularly preferably the reactive mixture (rM2) comprises in the range from 10 to 60% by weight of component (A) and in the range from 40 to 90% by weight of component (B) based on the sum of the percentages by weight of components (A) and (B), preferably based on the total weight of the reactive mixture (rM2).

Unless otherwise indicated all of the percentages by weight of components (A) and (B) as well as of the optionally comprised component (C) are based on the composition of the reactive mixture (rM2) before the beginning of the polymerization of the reactive mixture (rM2).

The molar ratio of component (A) to component (B) in the reactive mixture (rM2) is for example in the range from 10:1 to 1:10.

Preferably, the molar ratio of component (A) to component (B) in the reactive mixture (rM2) is in the range from 6:1 to 1:5.

Most preferably, the molar ratio of component (A) to component (B) in the reactive mixture (rM2) is in the range from 3:1 to 1:2.

Most preferred is therefore a pyrrolidone-containing polymer (PP) wherein the molar ratio of component (A) to component (B) in the reactive mixture (rM2) is in the range from 3:1 to 1:2.

Also preferred is a pyrrolidone-containing polymer (PP) wherein the molar ratio of component (A) to component (B) in the reactive mixture (rM2) is in the range from 3:1 to 1:10.

As described above for the percentages by weight, the molar ratio also relates to the molar ratio of component (A) to component (B) before the start of the polymerization, i.e. before components (A) and (B) have reacted with one another.

The reactive mixture (rM2) may further comprise a component (C), i.e. at least one catalyst.

Suitable components (C) have been described above.

The reactive mixture (rM2) preferably comprises additionally component (C), at least one catalyst selected from the group consisting of phosphoric acid, alkali metal dihydrogen phosphates, alkali metal hypophosphites, alkali metal hydrogen sulfates, tin octanoates, titanium(IV)butoxide and bismuth-2,2-diphenylundecanoate.

Alkali metal hypophosphites are preferred as component (C) and suitable alkali metal hypophosphites are described herein above. Sodium hypophosphite is particularly preferred as component (C).

For example, the reactive mixture (rM2) comprises in the range from 0.1 to 5% by weight of component (C), preferably in the range from 0.1 to 3% by weight and particularly preferably in the range from 0.1 to 2% by weight, based on the sum of the percentages by weight of components (A), (B) and (C), preferably based on the total weight of the reactive mixture (rM2).

To the person skilled in the art it is understood that the percentages by weight of components (A) and (B) as well as optional component (C) usually add up to 100% by weight.

The polymerization of the reactive mixture (rM2) may be carried out in the presence of at least one solvent (S).

Suitable solvents (S) are known to the skilled person and have been described above. Preferably, the at least one solvent (S) is water.

Component (A) is at least one itaconic acid derivative. Within the context of the present invention “itaconic acid derivative” comprises itaconic acid as such and also itaconic acid derivatives according to their common meaning. Suitable itaconic acid derivatives as such are known to the skilled person.

Suitable itaconic acid derivatives are, therefore, for example itaconic acid, itaconic anhydride, itaconic esters and itaconyl halides.

Preferably, component (A) is selected from the group consisting of itaconic acid, itaconic anhydride, itaconic esters and itaconyl halides.

Itaconic acid is also known as 2-methylidenebutanedioic acid, as 2-methylenesuccinic acid or as 1-propene-2,3-dicarboxylic acid. Itaconic acid has the CAS-number 97-65-4.

Itaconic anhydride is also known as 2-methylenesuccinic anhydride or as itaconic acid anhydride. Itaconic anhydride has the CAS-number 2170-03-8.

Suitable itaconic esters are reaction products of itaconic acid with alkyl alcohols. Preferred alkyl alcohols are methanol, ethanol, propanol and butanol. Preferred itaconic esters are dimethyl itaconic ester and diethyl itaconic ester.

Preferred itaconyl halides are itaconyl chloride and itaconyl bromide, itaconyl chloride is particularly preferred.

Therefore, component (A) is preferably selected from the group consisting of itaconic acid, itaconic anhydride, dimethyl itaconic ester, diethyl itaconic ester and itaconyl chloride. Particular preference is given to itaconic acid as component (A).

Component (B) is at least one amino acid of the general formula (1)

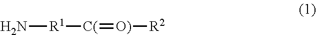

wherein
R¹ is selected from the group consisting of at least monosubstituted C₂-C₂₀-alkanediyl and at least monosubstituted C₃-C₂₀-cycloalkanediyl, wherein the substituent is NH₂;
R² is selected from the group consisting of Cl, Br and OR³, wherein
R³ is selected from the group consisting of H, C₁-C₁₀-alkyl, C₃-C₁₀-cycloalkyl and C₂-C₁₅-alkenyl.

Preferably,
R¹ is selected from the group consisting of at least monosubstituted C₂-C₂₀-alkanediyl, wherein the substituent is NH₂,
R² is selected from the group consisting of OH and Cl.

Particularly preferably,
R¹ is selected from the group consisting of monosubstituted C₃-C₁₀-alkanediyl, wherein the substituent is NH₂, in particular linear and saturated C₄, C₅ or C₆, preferably C₅-alkanediyl, with the NH₂ substituent being located on the most distal carbon atom;
R² is OH.

In a preferred embodiment, component (B) is selected from the group consisting of L-Lysine, D-Lysine and racemic mixtures of L-Lysine and D-Lysine.

“C₂-C₂₀-alkanediyl” as described for example above for R¹ of the general formula (1) means in the context of the present invention a hydrocarbon having 2 to 20 carbon atoms and two free valences. It is therefore a biradical having 2 to 20 carbon atoms. “C₂-C₂₀-alkanediyl” encompasses both linear and branched, and also saturated and unsaturated, hydrocarbons having 2 to 20 carbon atoms and two free valences. Saturated hydrocarbons are preferred. Examples of C₂-C₂₀-alkanediyls include, without limitation, ethylene (ethane-1,2-diyl, dimethylene), propane-1,3-diyl (trimethylene), propylene (propane-1,2-diyl), and butane-1,4-diyl (tetramethylene) as well as n-pentane-1,5-diyl. In some embodiments, linear moieties may be preferred. Corresponding observations apply in respect to “C₃-C₁₀-alkanediyl”.

“C₃-C₂₀-cycloalkanediyl” as described for example above for R¹ of the general formula (1) means in the context of the present invention a cyclic hydrocarbon having 3 to 20 carbon atoms and two free valences. It is therefore a biradical having 3 to 20 carbon atoms. “C₃-C₂₀-cycloalkanediyl” encompasses both cyclic hydrocarbons and hydrocarbons having a cyclic fraction and a linear fraction having 3 to 20 carbon atoms and two free valences. Examples of C₃-C₂₀-cycloalkanediyls, include, without limitation, cyclopropanediyl, cyclobutanediyl, cyclopentanediyl, cyclohexanediyl, cycloheptanediyl, cyclooctanediyl and cyclodecanediyl.

Within the context of the present invention, “C₁-C₁₀-alkyl” as described for example above for R³ of the general formula (1) means a hydrocarbon radical with a carbon atom number from 1 to 10. The alkyl radical may be linear or branched. Examples of such alkyl radicals include, but are not limited to, methyl, ethyl, n-propyl, iso-propyl, butyl, iso-butyl, sec-butyl, tert-butyl, n-pentyl, iso-pentyl and octyl.

Within the context of the present invention, “C₃-C₁₀-cycloalkyl” as described for example above for R³ of the general formula (1) means a cyclic hydrocarbon radical with a carbon atom number from 3 to 10. “C₃-C₁₀-cycloalkyl” also encompasses hydrocarbons having a cyclic fraction and a linear fraction having 3 to 10 carbon atoms and one free valence. Examples of such cycloalkyl radicals include, but are not limited to, cyclopropyl, cyclobutyl, cyclopentyl, cyclohexyl, cycloheptyl, cyclooctyl and cyclodecyl.

Within the context of the present invention, “C₂-C₁₅-alkenyl” as described for example above for R³ of the general formula (1) means an unsaturated hydrocarbon radical having at least one C—C-double bond and 2 to 15 carbon atoms. Examples of such C₂-C₁₅-alkenyls include, without limitation, ethenyl, propenyl, butenyl, pentenyl and hexenyl.

The pyrrolidone-containing polymer (PP) is obtainable by polymerization of the reactive mixture (rM2). For example, the polymerization of the reactive mixture (rM2) is carried out at temperatures in the range of from 50 to 300° C., preferably in the range of from 70 to 250° C. and particularly preferably in the range of from 90 to 240° C.

The polymerization can be carried out as a one step process or as a multi-step process. These processes are known to the person skilled in the art and are described in more detail below with respect to the process for producing the pyrrolidone-containing polymer (PP).

During the polymerization, components (A) and (B) undergo a polycondensation reaction to form the pyrrolidone-containing polymer (PP).

“Pyrrolidone-containing polymer (PP)” within the context of the present invention means that the polymer comprises pyrrolidonyl groups, typically and preferably a part of its backbone (and not as pendant groups). Thus, within the context of the present invention, the pyrrolidone-containing polymer (PP) is also referred to as “pyrrolidonyl-containing polymer (PP)”. The terms “pyrrolidone-containing polymer (PP)” and “pyrrolidonyl-containing polymer (PP)” are therefore used synonymously throughout the present invention and have the same meaning.

The pyrrolidone-containing polymer (PP) according to the present invention comprises units which are derived from components (A) and (B).

Therefore, the pyrrolidone-containing polymer (PP) may comprise units which result from the reaction of component (A) with component (B). The pyrrolidone-containing polymer (PP) may also comprise units which result from the reaction of two components (B).

The pyrrolidone-containing polymer (PP) may be linear or branched. In particular if the pyrrolidone-containing polymer (PP) comprises units which result from the reaction of two components (B), the pyrrolidone-containing polymer (PP) may be branched.

In a preferred embodiment, the pyrrolidone-containing polymer (PP) comprises at least one unit of the general formula (A)

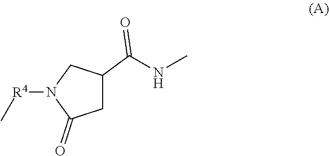

wherein
R⁴ is selected from the group consisting of at least monosubstituted C₂-C₂₀ alkanediyl and C₃-C₂₀cycloalkanediyl, wherein at least one substituent is C(═O)R², wherein
R² is selected from the group consisting of Cl, Br and OR³, wherein
R³ is selected from the group consisting of H, C₁-C₁₀ alkyl, C₃-C₁₀ cycloalkyl and C₂-C₁₅ alkenyl.
R⁴ is preferably selected from the group consisting of at least monosubstituted C₂-C₂₀-alkanediyl, wherein at least one substituent is C(═O)R², wherein
R² is selected from the group consisting of OH and Cl.

R⁴ is most preferably selected from the group consisting of monosubstituted C₃-C₁₀-alkanediyl, wherein the substituent is C(═O)OH. In such embodiments, R⁴ may be linear and saturated monosubstituted C₃-C₆ alkanediyl, in particular C₄, C₅ or C₆, preferably C₅-alkanediyl.

The pyrrolidone-containing polymer (PP) for example has a weight average molecular weight (M_{w}) in the range from 500 to 100,000 g/mol, preferably in the range from 1,000 to 50,000 g/mol and particular preferably from 1,000 to 10,000 g/mol, determined by gel permeation chromatography (GPC) with 0.1% (w/w) trifluoroacetic acid, 0.1 M NaCl in distilled water as solvent.

The number average molecular weight (Mₙ) of the pyrrolidone-containing polymer (PP) is preferably in the range from 500 to 20,000 g/mol, particular preferably in the range from 500 to 10,000 g/mol and most preferably in the range from 500 to 5,000 g/mol, determined by size exclusion chromatography (SEC) using as solvent: Water/Methanol (80/20)+0.01 mol/I Phosphate buffer pH=7.4.

The polydispersity (PD) of the pyrrolidone-containing polymer (PP) is typically in the range from 1.1 to 5, preferably in the range 1.1 to 4 and most preferably in the range from 1.1 to 3. The polydispersity (PD) is the ratio between the weight average molar weight (M_{w}) and the number average molecular weight (Mₙ) of the pyrrolidone-containing polymer (PP).

The amino number of the inventive pyrrolidone-containing polymer (PP) is for example in the range from 20 to 500 mg KOH/g, preferably in the range from 50 to 450 mg KOH/g and most preferably in the range from 75 to 400 mg KOH/g determined by titration. Suitable titration is known to the skilled person and described in further details exemplarily in the examples of the invention.

As above mentioned, the present invention relates in an eighth aspect to a process for producing a pyrrolidone-containing polymer (PP), wherein the process comprises polymerization of a reactive mixture (rM2), wherein the reactive mixture (rM2) comprises at least the following components
(A) at least one itaconic acid derivative, and
(B) at least one amino acid of the general formula (1)

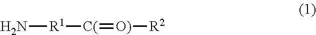

wherein
R¹ is selected from the group consisting of at least monosubstituted C₂-C₂₀ alkanediyl and at least monosubstituted C₃-C₂₀ cycloalkanediyl, wherein the substituent is NH₂;
R² is selected from the group consisting of Cl, Br and OR³, wherein
R³ is selected from the group consisting of H, C₁-C₁₀ alkyl, C₃-C₁₀ cycloalkyl and C₂-C₁₅ alkenyl.

Preferred embodiments are the same that have been disclosed in connection with the other aspects of the invention above. Particularly preferred embodiment are disclosed in the following.

In a preferred embodiment, the reactive mixture (rM2) comprises additionally component (C), i.e. at least one catalyst selected from the group consisting of phosphoric acid, alkali metal dihydrogen phosphates, alkali metal hypophosphites, alkali metal hydrogen sulfates, tin octanoate, titanium(IV)butoxide and bismuth-2,2-diphenylundecanote.

The polymerization of the reactive mixture (rM2) can be carried out by any method known to the skilled person. Preferably, the polymerization of the reactive mixture (rM2) is carried out in the presence of at least one solvent (S).

Suitable solvents (S) are known to the skilled person and have been described above. Preferably, the at least one solvent (S) is water.

Preferably, the polymerization of the reactive mixture (rM2) comprises the following steps:
a) heating the reactive mixture (rM2) in the presence of at least one solvent (S) to a first temperature (T₁) to obtain a prepolymerized mixture (pM2) comprising pyrrolidone-containing prepolymers and the at least one solvent (S),
b) removing the at least one solvent (S) from the prepolymerized mixture (pM2) obtained in step a) to obtain a solvent-free prepolymerized mixture (spM2), comprising the pyrrolidone-containing prepolymers,
c) heating the solvent-free prepolymerized mixture (spM2) obtained in step b) to a second temperature (T₂) which is higher than the first temperature (T₁) to obtain the pyrrolidone-containing polymer (PP).

The heating of the reactive mixture (rM2) in step a) can be carried out by any method known to the skilled person. The reactive mixture (rM2) can be stirred during the heating. Preferably, step a) is carried out under inert gas. Suitable inert gases for step a) are known to the skilled person and are, for example, nitrogen and/or argon.

For example, in step a) in the range of from 20 to 100% by weight of the reactive mixture (rM2) are heated in the presence of at least one solvent (S), based on the sum of the percentages by weight of the reactive mixture (rM2) and the at least one solvent (S). Preferably, in the range from 20 to 99% by weight of the reactive mixture (rM2) are heated in the presence of at least one solvent (S) in step a), based on the sum of the percentages by weight of the reactive mixture (rM2) and the at least one solvent (S).

Thus, in one embodiment of the present invention no solvent (S) is present in step a). The polymerization of the reactive mixture (rM2) then comprises the following steps:
a1) heating the reactive mixture (rM2) to a first temperature (T₁) to obtain a prepolymerized mixture (pM2) comprising pyrrolidone-containing prepolymers,
c1) heating the prepolymerized mixture (pM2) obtained in step a1) to a second temperature (T₂) which is higher than the first temperature (T₁) to obtain the pyrrolidone-containing polymer (PP).

The first temperature (T₁) to which the reactive mixture (rM2) is heated in step a) and in step a1) is typically in the range of from 50 to 150° C., preferably in the range of from 90 to 120° C.

The reactive mixture (rM2) can then be held at the first temperature (T₁). For example, the reactive mixture (rM2) can be held at the first temperature (T₁) for 15 minutes to 24 hours preferably for 30 minutes to 15 hours.

At the first temperature (T₁) the components comprised in the reactive mixture (rM2), in particular components (A) and (B) react with one another to form oligomers comprising pyrrolidone groups. This reaction is also called a prepolymerization of components (A) and (B).

In step a) pyrrolidone-containing prepolymers are obtained.

“Pyrrolidone-containing prepolymers” within the context of the present invention means that the prepolymers comprise pyrrolidonyl groups. Thus, within the context of the present invention, the pyrrolidone-containing prepolymers are also referred to as “pyrrolidonyl-containing prepolymers”. The terms “pyrrolidone-containing prepolymers” and “pyrrolidonyl-containing prepolymers” are therefore used synonymously throughout the present invention and have the same meaning.

The at least one solvent (S) can be removed in step b) from the prepolymerized mixture (pM2) by any method known to the skilled person. For example, the at least one solvent (S) can be removed at reduced pressure and/or higher temperatures than the first temperature (T₁) and below the decomposition temperature of the pyrrolidone-containing prepolymers.

A solvent-free prepolymerized mixture (spM2) is obtained in step b). The solvent-free prepolymerized mixture (spM2) typically comprises less than 5% by weight, preferably less than 2% by weight and particularly preferably less than 1% by weight of the at least one solvent (S), based on the total weight of the solvent-free prepolymerized mixture (spM2).

The heating of the solvent-free prepolymerized mixture (spM2) in step c) can be carried out by any method known to the skilled person. The solvent-free prepolymerized mixture (spM2) can be stirred during the heating. Preferably, step c) is carried out under inert gas. Suitable inert gases are known to the skilled person. Suitable inert gases are for example nitrogen and/or argon.

Preferably step c) is carried out at a pressure in the range of from 5 mbar to 50 bar, preferably in the range of from 10 mbar to 5 bar, most preferably in the range of from 10 mbar to 2 bar.

The second temperature (T₂) to which the solvent-free prepolymerized mixture (spM2) is heated in step c) is above the first temperature (T₁) to which the reactive mixture (rM2) is heated in step a). For example, the second temperature (T₂) is in the range of from 100 to 300° C., preferably in the range of from 120 to 250° C.

The solvent-free prepolymerized mixture (spM2) can then be held at the second temperature (T₂). For example, the solvent-free prepolymerized mixture (spM2) is held at the second temperature (T₂) for 15 minutes to 10 hours, preferably for 15 minutes to 5 hours.

During the heating in step c), the solvent-free prepolymerized mixture (spM2) polymerizes to obtain the pyrrolidone-containing polymer (PP).

For step c1) the embodiments and preferences described for step c) similarly apply.

After step c) or step c1), a step d) can be carried out. Step d) can, for example, be selected from the group of a hydrophobizing step, an alkoxylation step and a quaternization step.

These steps are known as such to the skilled person.

In a hydrophobizing step, the pyrrolidone-containing polymer (PP) is reacted with a compound which is hydrophobic so that a pyrrolidone-containing polymer (PP) is obtained which is less hydrophilic than before the reaction or even hydrophobic.

Suitable compounds with which the pyrrolidone-containing polymer (PP) can be reacted in the hydrophobizing step are, for example, selected from the group consisting of fatty acids, activated fatty acids, polyisobutylene succinic anhydride and caprolactone. Suitable activated fatty acids are, for example, fatty acid anhydrides, fatty acid esters or fatty amines. These compounds are known to the skilled person.

In an alkoxylation step, an epoxide compound is reacted with the pyrrolidone-containing polymer (PP). Epoxide compounds are also called alkylene oxides. Suitable alkylene oxides are, for example, ethylene oxide, propylene oxide and butylene oxide.

In a quaternization step, the nitrogen atoms of the pyrrolidonyl-containing polymer (PP) are reacted with a quaternizing agent to obtain quaternary ammonium cations in the pyrrolidone-containing polymer (PP). Suitable quaternizing agents are known to the skilled person and are, for example, selected from the group consisting of alkyl halides and dialkyl sulfates. Suitable alkyl halides are, for example, methyl chloride, ethyl chloride, methyl bromide, ethyl bromide and/or benzyl chloride. Suitable dialkyl sulfates are for example selected from the group consisting of dimethyl sulfate and diethyl sulfate. Organic acids, such as lactic acid, are suitable as quaternizing agents, as well.

In a preferred embodiment, the process additionally comprises at least one step selected from the group consisting of a hydrophobizing step, an alkoxylation step and a quaternization step.

### Examples

The invention is illustrated in further detail by the following, non-limiting examples.

### Starting Materials and Methods

Itaconic acid was purchased form Sigma-Aldrich (>99% purity)

L-Lysine (ADM, 50% water solution if specifically not stated otherwise, in Spray drying aid 15 from Sigma Aldrich, purity >98%, is used)

Sodium hypophosphite monohydrate (Sigma Aldrich, >99% purity) was used as component (C)

### Number Average Molecular Weight (Mn) and Weight Average Molecular Weight (Mw):

### Spray Drying Aid 1 to 9:

Weight average molecular weight (Mw) was determined by gel permeation chromatography (GPC) with 0.05 M aqueous ammonium formate/methanol mixture=80:20 (parts by volume) as eluent.

Number average molecular weight (Mn) was determined by gel permeation chromatography (GPC) with 0.05 M aqueous ammonium formate/methanol mixture=80:20 (parts by volume) as eluent.

Determination of the molecular weight (Mass average molar mass (Mw) and number average molar mass (Mn)) of the polymers was performed as follows: The sample was prepared for the determination of molar mass by dissolving copolymer solution in the GPC eluent, such that the polymer concentration in the GPC eluent is 0.5% by weight. Thereafter, this solution was filtered through a syringe filter having a polyethersulfone membrane and pore size 0.45 μm. The injection volume of this filtrate was 50-100 μL. The average molecular weights were determined on a Waters GPC instrument with the model name Alliance 2690 with a UV detector (Waters 2487) and RI detector (Waters 2410). The following settings and conditions were used:
Columns: Shodex SB-G Guard Column for SB-800 HQ series and Shodex OHpak SB 804HQ and 802.5HQ (PHM gel, 8×300 mm, pH 4.0 to 7.5)
Eluent: 0.05 M aqueous ammonium formate/methanol mixture=80:20 (parts by volume)
Flow rate: 0.5 mL/min
Temp.: 50° C.
Injection: 50 to 100 μL
Detection: RI and UV

Depending on the nature of the copolymers, their molecular weights were determined relative to poly(ethylene glycol) and poly(ethylene oxide) or polyacrylic acid standards from PSS Polymer Standards Service GmbH. The molecular weight distribution curves of the polyacrylic acid standards were determined by means of light scattering.

### Spay Drying Aid 10 to 14:

Measured via size exclusion chromatography under the following conditions:
Solvent: Water/Methanol (80/20)+0.01 molI/Phosphate buffer pH=7.4
Flow: 0.8 ml/min
Injection volume: 20 μl
Column material: hydroxylated polymethacrylate (TSKgel G3000PWXL)
Calibration: Polyvinylpyrrolidone-Standards in the molar mass range from 3500 g/mol to 710 000 g/mol (from Polymer American Standards, USA)

### Spray Drying Aid 15 and 16:

Gel permeation chromatography (GPC) was performed with a conventional GPC apparatus equipped with columns PL HFIP Gel (styrene divinylbenzene copolymer) (7.5×300 mm) and PL HFIP Gel (SVD) (7.5×300 mm) and a refractive index (RI) detector. The column was kept at a temperature of 35° C. and the samples eluted with hexafluoroisopropanol with 0.05% potassium trifluoroacetate at a flow rate of 1 ml/min. For each analysis, 50 μl of a 1.5 mg/ml solution were injected. The GPC calibration was carried out with our PMMA standards (800-1 820 000 g/mol) from PSS—Polymer Standards Service GmbH (Germany).

### Amino Number:

The amino number (unit: mg KOH/g), also referred to as amino number, was determined by titration. A potentiograph equipped with a Dosimat with 10 ml interchangeable burette and a combined glass-Ag/AgCl-electrode, e.g. titroprocessor type 726 with Dosimat 685 (Metrohm), was used. About 0.1 to 1.0 g of sample (the exact mass was chosen according to the expected amine number) were mixed with 50 ml of glacial acetic acid in a 100 ml beaker to obtain a solution. The solution was titrated with 0.1 N trifluoromethanesulfonic acid (standard solution in glacial acetic acid, c(CF3SO3H)=0.1 mol/1) until the inflection point at a potential of about 600 mV was reached. A blank value was determined using the solvent.

### Calculation of the Amine Number:

$$Amine number = \frac{( {V}_{P} - {V}_{B} ) \cdot t \cdot c \cdot 56.1}{E} = \frac{( {V}_{P} - {V}_{B} ) \cdot t}{E} \cdot 5.61$$

with
Amine number: Fraction of total amine calculated as mg KOH/g
VP: Consumption of standard solution up to the inflection point [ml]
VB: Consumption of standard solution in blank value titration [ml]
t: titer of standard solution
c: concentration of standard solution [=0.1 mol/l]
E: weight of sample taken [g]
56.1 is the molar weight of KOH [g/mol]

For the examples and comparative examples, the following starting materials were used:

### Spray Drying Aids:

### Spray Drying Aid 1:

In a reaction vessel (four-necked flask) equipped with reflux condenser, stirrer, thermometer, dropping funnel, and nitrogen sparging, a solution of 520.4 g itaconic acid, 123.6 g ethylenediamine, and 500 mL water was stirred and heated under reflux for one hour.

Afterwards, 208.5 g of 1,5-pentanediamine was added. The water was removed trough a distillation apparatus under normal pressure and later by applying a vacuum. In parallel, the reaction mixture was slowly heated to 180° C. At a vacuum of <2 mbar, the reaction was continued until the stirrer showed a torque of 20 Ncm. The obtained polymer has a K-value of 20.6, a molecular weight of M_{W}˜5020 g/mol, and M_{N}˜2350 g/mol.

### Spray Drying Aid 2:

In an analogous way to the synthetic procedure as described for the spray drying aid 1, the spray drying aid 2 was synthesized using 339.9 g itaconic acid and 133.5 g 1,5-pentanediamine. Afterwards, 39.5 g ethylenediamine and 67.1 g of 1,5-pentanediamine were added. Followed by the same treatment, as described for spray drying aid 1. The obtained polymer has a K-value of 18.6, a molecular weight of M_{W}˜4690 g/mol, and M_{N}˜2190 g/mol.

### Spray Drying Aid 3:

In an analogous way to the synthetic procedure as described for the spray drying aid 1, the spray drying aid 3 was synthesized using 390.3 itaconic acid and 92.0 g ethylenediamine. Afterwards, 46.0 g ethylenediamine and 78.2 g of 1,5-pentanediamine were added. Followed by the same treatment, as described for spray drying aid 1. The obtained polymer has a K-value of 16.5, a molecular weight of M_{W}˜4360 g/mol, and M_{N}˜2010 g/mol.

### Spray Drying Aid 4:

526.32 g of 50% water solution of L-Lysine (1.8 mol) were placed in a 2 L four-necked flask equipped with a stirrer a condensation column, a thermometer, and a Nitrogen inlet. To the L-Lysine solution 117.09 g of itaconic acid (0.9 mol) were added. The mixture was heated under stirring and under inert atmosphere (N2 flow) to the boiling point and kept under reflux for 10 h. Then, the temperature of the external heat source was increased according to the following profile 1 h at 150° C., 1 h at 160° C., 1 h at 170° C., and 1 h at 180° C. while water was distilled off. The warm reaction melt was collected in an aluminum vessel. At room temperature, a solid material was obtained. The obtained polymer has an amino number of 308 mg KOH/g. The polymer has a molecular weight of M_{W}˜2410 g/mol, and M_{N}˜2175 g/mol.

### (Ref.) Spray Drying Aid 5:

Commercially available polyacrylamide (PAM; catalog No. 22581) in water, which is manufactured by Polysciences Inc. The polymer has a solids content of 50% by weight and a molecular weight of M_{W}˜10000 g/mol.

### (Ref.) Spray Drying Aid 6:

In a reaction vessel equipped with reflux condenser, stirrer, thermometer, dropping funnel, and nitrogen sparging, an initial charge of 280 g of water and 195 g of Na-2-acrylamido-2-methylpropanesulfonic acid (AMPS) was heated to 18° C. While stirring, 70 g of a 50% sodium hydroxide solution were added dropwise at 18° C. Subsequently, 68 g of acrylic acid, 2.8 g of 2,2′-azobis(2-methylpropionamidine) dihydrochloride (Wako V50) and 4 g of mercaptoethanol were metered in while stirring over a period of 10 min. The reaction solution was stirred at 70 to 80° C. for 1.5 h and then cooled down to room temperature. The resulting product was a clear polymer solution having a solids content of 48.1% by weight, a pH of 0.8, and a molecular weight M_{W} of about 8400 g/mol.

### (Ref.) Spray Drying Aid 7:

In a reaction vessel equipped with reflux condenser, stirrer, thermometer, dropping funnel, and nitrogen sparging, an initial charge of 350 g of water and 313 g of Na-2-acrylamido-2-methylpropanesulfonic acid (AMPS) was heated to 18° C. While stirring, 112 g of a 50% sodium hydroxide solution were added dropwise at 18° C. Subsequently, 27 g of acrylic acid, 2.8 g of 2,2′-azobis(2-methylpropionamidine) dihydrochloride (Wako V50) and 6 g of mercaptoethanol were metered in while stirring over a period of 14 min. The reaction solution was stirred at 70 to 80° C. for 1.5 h and then cooled down to room temperature. The resulting product was a clear polymer solution having a solids content of 48.5% by weight, a pH of 0.8, and a molecular weight M_{W} of about 7400 g/mol.

### (Ref.) Spray Drying Aid 8: Poval® 4-88

Commercially available partially saponified polyvinyl alcohol (PVOH) is a solid, has a degree of hydrolysis of 86.7-88.7 mol %, non-volatile parts of 97.5±2.5% (measured after a drying time of 3 hours at 105° C. according to DIN 53189/JIS K 6726), and has a viscosity of 3.5-4.5 mPa*s as a 4% aqueous solution at 20° C. (according to DIN 53015/JIS K 6726). The polymer is manufactured by Kuraray and is available under the trade name Poval® 4-88.

### (Ref.) Spray Drying Aid 9:

A polyacid based on the monomers methacrylic acid and 2-methyl-2-propene-1-sulfonic acid. This polyacid has a molecular weight of M_{W}˜1400 g/mol and was synthesized as described in US 2020/0207671 A1 page 10, paragraph 0234 to paragraph 0235.

### Spray Drying Aid 10:

380.10 g of 50% water solution of L-Lysine (1.3 mol) were placed in a 2 L four-necked flask equipped with a stirrer, a condensation column, a thermometer and a Nitrogen inlet. To the L-Lysine solution, 169.10 g of itaconic acid (1.3 mol) and 5.9 g Sodium Hypophosphite monohydrate were added. The mixture was heated under stirring and under inert atmosphere (N₂ flow) to the boiling point and kept under reflux for 10 h (hours). Then the temperature of the external heat source was increased according to the following profile 3 h at 150° C., 2 h at 160° C. while water was distilled off. The pressure was then decreased to 600 mbar while the external heat source was increased to 180° C. The reaction for circa 1 hour continued under vacuo (600 mbar). The warm reaction melt was collected in an aluminum vessel. At room temperature (20° C.), a solid material was obtained. The obtained polymer has an amino number of 122 mg KOH/g, a molecular weight of Mn˜3290 g/mol, Mw˜4350 g/mol, and a PD˜1.3.

### Spray Drying Aid 11:

380.10 g of 50% water solution of L-Lysine (1.3 mol) were placed in a 2 L four-necked flask equipped with a stirrer a condensation column, a thermometer and a Nitrogen inlet. To the L-Lysine solution, 169.10 g of itaconic acid (1.3 mol) were added. The mixture was heated under stirring and under inert atmosphere (N₂ flow) to the boiling point and kept under reflux for 10 h. Then the temperature of the external heat source was increased according to the following profile 1 h at 150° C., 2 h at 160° C. while water was distilled off. The pressure was then decreased to 600 mbar while the external heat source was increased to 180° C. The reaction for circa 20 minutes continued under vacuo (600 mbar). The warm reaction melt was collected in an aluminum vessel. At room temperature (20° C.), a solid material was obtained. The obtained polymer has an amino number of 132 mg KOH/g, a molecular weight of Mn˜3020 g/mol, Mw˜3840 g/mol, and a PD˜1.3.

### Spray Drying Aid 12:

526.32 g of 50% water solution of L-Lysine (1.8 mol) were placed in a 2 L four-necked flask equipped with a stirrer a condensation column, a thermometer and a Nitrogen inlet. To the L-Lysine solution, 117.09 g of itaconic acid (0.9 mol) were added. The mixture was heated under stirring and under inert atmosphere (N₂ flow) to the boiling point and kept under reflux for 10 h. Then the temperature of the external heat source was increased according to the following profile 1 h at 150° C., 1 h at 160, 1 h at 170° C. and 1 h at 180° C. while water was distilled off. The warm reaction melt was collected in an aluminum vessel. At room temperature (20° C.), a solid material was obtained. The obtained polymer has an amino number of 373 mg KOH/g, a molecular weight of Mn˜2020 g/mol, Mw˜2260 g/mol, and a PD˜1.1.

### Spray Drying Aid 13:

380.10 g of 50% water solution of L-Lysine (1.3 mol) were placed in a 2 L four-necked flask equipped with a stirrer a condensation column, a thermometer and a Nitrogen inlet. To the L-Lysine solution 169.10 g of itaconic acid (1.3 mol) were added. The mixture was heated under stirring and under inert atmosphere (N₂ flow) to the boiling point and kept under reflux for 10 h. Then the temperature of the external heat source was increased according to the following profile 1 h at 150° C., 4 h at 160° C., 1 h at 170° C. while water was distilled off. The pressure was then decreased to 430 mbar while the external heat source was increased to 180° C. The reaction for circa 40 minutes continued under vacuo (430 mbar). The warm reaction melt was collected in an aluminum vessel. At room temperature (20° C.), a solid material was obtained. The obtained polymer has an amino number of 101 mg KOH/g, a molecular weight of Mn 3820 g/mol, Mw˜5520 g/mol, and a PD˜1.4.

### Spray Drying Aid 14:

380.10 g of 50% water solution of L-Lysine (1.3 mol) were placed in a 2 L four-necked flask equipped with a stirrer a condensation column, a thermometer and a Nitrogen inlet. To the L-Lysine solution 169.10 g of itaconic acid (1.3 mol) and 5.49 g of Natrium hypophosphite were added. The mixture was heated under stirring and under inert atmosphere (N₂ flow) to the boiling point and kept under reflux for 10 h. Then the temperature of the external heat source was increased according to the following profile 1 h at 150° C., 4 h at 160° C., 30 minutes at 170° C. while water was distilled off. The pressure was then decreased to 430 mbar while the external heat source was increased to 180° C. The reaction for circa one hour continued under vacuo (430 mbar). The warm reaction melt was collected in an aluminum vessel. At room temperature (20° C.), a solid material was obtained. The obtained polymer has an amino number of 75 mg KOH/g, a molecular weight of Mn˜4740 g/mol, Mw˜8060 g/mol, and a PD˜1.7.

### Spray Drying Aid 15:

52.04 g Itaconic acid, 58.48 g L-Lysin and 50 g of water were placed into a 500 mL four-necked flask equipped with a stirrer, a condensation column, a thermometer and a Nitrogen inlet. The mixture was heated to 130 C and the water was distilled off within 40 minutes. Then the temperature was increased to 160° C. and further condensed for 15 minutes. The obtained polymer has a molecular weight of Mn˜904 g/mol, Mw˜1190 g/mol, and a PD˜1.31.

### Spray Drying aid 16:

52.04 g Itaconic acid, 40.8 g 1,5-Pentamethylendiamine and 50 g of water were placed into a 500 mL four-necked flask equipped with a stirrer, a condensation column, a thermometer and a Nitrogen inlet. The mixture was heated to 130° C. and the water was distilled off within 40 minutes. Then the temperature was increased to 160° C. and further condensed for 15 minutes. The obtained polymer has a molecular weight of Mn˜1030 g/mol, Mw˜1480 g/mol, and a PD 1.43.

### Aqueous Dispersions

### Dispersion 1:

The dispersion was synthesized according to a styrene-acrylate as described in US 2020/0207671 A1: Dispersion 1 at page 9. The obtained polymer has a solids content of 55% by weight, a glass transition temperature of −15° C., and a particle size of about 600 nm.

### Dispersion 2:

The dispersion is based on the same composition as dispersion 1 and additionally comprises 3 parts per hundred monomers (pphm) methoxy polyethylene glycol (MPEG) with a M_{W} of 750 g/mol and 2.5 pphm acrylic acid. The obtained polymer has a solids content of 54.6% by weight, a glass transition temperature of −15° C., and a particle size of about 730 nm.

### Dispersion 3:

The dispersion was synthesized according to a styrene-acrylate dispersion which was produced by emulsion polymerization as described in WO 2013/117465 A1: Example “Polymerisatdispersion D” on page 19-20. The dispersion has a solids content of 57% by weight, a glass transition temperature of −13° C., and a particle size of 230 nm.

### Dispersion 4:

The dispersion based on styrene-acrylate. The polymer has a solids content of 60% by weight, a glass transition temperature of −8 to −10° C., and a particle size of about 550 nm. The dispersion comprises 68.5 pphm n-butyl acrylate, 28.5 pphm styrene, and 3 pphm acrylic acid. The dispersion is stabilized by 2 wt.-% emulsifier (fatty alcohol (C₁₂-C₁₄) ether sulfates having an ethoxylation degree of ˜30 EO units.

### Dispersion 5:

The aqueous styrene-butadiene latex dispersion has a solids content of 51 wt.-%, a glass transition temperature of 18° C., and a pH˜8. The average particle size (D 50 value) of the polymer particles as measured by dynamic light scattering is 185 nm and the dispersion is stabilized by emulsifiers. The dispersion comprises 66.0 pphm styrene, 32.0 pphm butadiene, and 2.1 pphm acrylonitrile.

### Dispersion 6:

Commercially available aqueous dispersion VINNAPAS® 550 ED from Wacker. The dispersion based on a copolymer of vinyl acetate and ethylene and is stabilized by polyvinyl alcohol as protective colloid. The dispersion has a solids content of 53% by weight. The polymer has a minimum film forming temperature (MFFT) of ˜0° C. and a predominant particle size of 900 nm.

### Spray Drying of Dispersions

### A) Preparation of the Spray Dying Feed:

For making the dispersions to be spray dried, the aqueous polymer dispersion chosen (as described above) was mixed with the spray drying aid chosen (selected from spray drying aids No. 1 to No. 9 as described above) while stirring. The amounts of spray drying aid used are shown in Table 1.

Additional water was used to adjust the concentration of the dispersion to be dried to 44 wt.-% relating to the solids content in the spray feed.

### B) Spray Drying of the Dispersion:

Spray drying was conducted by means of a commercially available, laboratory-scale spray dryer (Niro Atomizer from Niro) using nitrogen as drying gas. The aqueous dispersion to be dried was sprayed through a two-fluid nozzle. The inlet temperature of the dryer gas was 130 to 140° C.; its outlet temperature was 60 to 70° C. A first anti-blocking agent (1 wt.-%) of hydrophobic silica powder, based on the total of all components of the final product) was fed into the drying chamber through an additional nozzle.

After removing the obtained powder from the spray dryer, it was mixed with 5-11 wt.-% (based on the total of all components of the final product) of a second anti-blocking agent, which were selected from commercially available anti-blocking agents, namely talc.

### Determination of the Re-Dispersibility of the RDP:

The composition composed of a dispersion with spray drying aid (SDA) specified in Table 1 was used to produce films and their re-dispersion was tested. For this purpose, the liquid dispersion (5 g of solids) in 10-15 mL of water was admixed with the described amount of the respective SDA and dried at room temperature for two days. About 0.5 g of the film was taken up in 10 mL of distilled water while stirring (200 rpm) at room temperature. On rapid re-dispersion within a few minutes, it was found that these dispersion systems also have excellent spray dry ability and a re-dispersible powder (RDP) is obtained.

Re-dispersion was assessed as follows:
Complete re-dispersion within a few minutes: very good
Virtually complete re-dispersion within a few minutes: good
Incomplete re-dispersion (parts of the film still apparent): moderate
Large parts of the film insoluble or no re-dispersion: poor

TABLE 1
Re-dispersibility of the different combinations
of dispersions and SDA as film and as RDP

| | | | Amount of SDA | Re- | Re- |
|---|---|---|---|---|---|
| | | | to s.c.* of the | dispersibility of | dispersibility of |
| Combination | Dispersion | SDA | dispersion | the film | the RDP |
| Example 1 | 1 | 1 | 10% | very good | very good |
| Example 2 | 1 | 2 | 10% | very good | good |
| Example 3 | 1 | 3 | 10% | moderate | moderate |
| Example 4 | 1 | 1 | 7% | good | very good |
| Example 5 | 2 | 4 | 10% | good | very good |
| Example 6 | 3 | 1 | 10% | good | good |
| Example 7 | 4 | 4 | 10% | good- | good |
| | | | | moderate | |
| Example 8 | 4 | 4 | 7% | good- | n.d.** |
| | | | | moderate | |
| Example 9 | 5 | 1 | 10% | good | moderate |
| Example 10 | 5 | 2 | 10% | good | n.d.** |
| Example 11 | 6 | 4 | 10% | moderate | moderate |
| (Ref.-)Example 12 | 1 | 5 | 10% | poor | n.d.** |
| (Ref.-)Example 13 | 3 | 5 | 10% | poor | n.d.** |
| (Ref.-)Example 14 | 4 | 5 | 10% | poor | n.d.** |
| (Ref.-)Example 15 | 5 | 5 | 10% | poor | n.d.** |
| (Ref.-)Example 16 | 1 | 6 | 10% | poor | n.d.** |
| (Ref.-)Example 17 | 1 | 7 | 10% | poor | n.d.** |
| (Ref.-)Example 18 | 3 | 6 | 10% | poor | n.d.** |
| (Ref.-)Example 19 | 3 | 7 | 10% | poor | n.d.** |
| (Ref.-)Example 20 | 4 | 6 | 10% | poor | n.d.** |
| (Ref.-)Example 21 | 1 | 8 | 10% | poor | n.d.** |
| (Ref.-)Example 22 | 3 | 8 | 10% | poor | n.d.** |
| (Ref.-)Example 23 | 4 | 8 | 10% | poor | n.d.** |
| (Ref.-)Example 24 | 1 | 9 | 10% | very good | very good |
| (Ref.-)Example 25 | 1 | 9 | 7% | very good | very good |
| (Ref.-)Example 26 | 3 | 9 | 7% | very good | very good |
| (Ref.-)Example 27 | 4 | 9 | 10% | poor | n.d.** |

*s.c. = solids content
**n.d. = not determined

### Application Tests

The influence of re-dispersible powders on the wet scrub resistance in a paint formulation was investigated according to EN 13300. Therefore, a dry formulation was produced according to Table 2 and mixed with 365.00 weight parts deionized water.

TABLE 2
Paint formulation (dry).

| Function / Constituents | weight parts |
|---|---|
| Base thickener, HEC, M_{W} 20000 | 4.00 |
| Dispersing agent (sodium salt of | 3.00 |
| a carboxylic acid copolymer in | |
| water; Dispex CX 4320) | |
| Defoamer (modified | 4.00 |
| polysiloxane) | |
| Rutile; titanium dioxide | 60.00 |
| Filler, fine alumina silicate | 20.00 |
| Filler, precipitated calcium | 50.00 |
| carbonate PCC | |
| Platelet filler, talc | 90.00 |
| Filler, calcite 2 μm | 80.00 |
| Filler, calcite 5 μm | 230.00 |
| Dispersion powder | 94.00 (latex content) |

If the dispersing agent was already co-spray dried with the dispersion, the dispersing agent has been removed from the formulation.

The wet scrub resistance of several combination was investigated according to EN 13300. The lower the abrasion after 200 cycles, the better is the paint formulation. The aqueous dispersions which were used for the RDPs showed the lowest abrasion, because no additional water-soluble polymer (SDA) without a function for the paint system is present.

TABLE 3
Wet scrub resistance of the formulation with RDPs.

| Example | Combination | Dispersion | SDA | Scrub [μm]*** |
|---|---|---|---|---|
| Test 1 | 1 | 1 | 1 | 29 |
| Test 2 | 2 | 1 | 2 | 45 |
| Test 3 | 3 | 1 | 3 | 46 |
| Ref.-Test 4 | 24 | 1 | 9 | 71 |

***after 200 cycles

In case of the polyacid-based SDA (spray drying aid 9), the resulting RDP is acidic and have to be neutralized in a paint, as described in DE 19601699 A1. Also for a construction material formulation neutralization would be needed. Further, the wet-scrub resistance is inferior compared to the polymers of this invention. If the polycarboxylic acids are neutralized before spray-drying the dispersion, the resulting dispersion powder re-disperses poorly, as described in WO 2018/224519.

### Biodegradability According to OECD301F

### Spray Drying Aid 4:

The test polymer (spray drying aid 4) was incubated with wastewater treatment sludge according to OECD301F. The amount of oxygen consumed by the microorganisms during biodegradation is followed using a manometric respirometer (Oxitop® bottle head). From the oxygen uptake, the biodegradation extent can be computed:
Example 3: 55-60% after 28 days (FIG. 1)

### Spray Drying Aid 12:

The test polymer (spray drying aid 12) was incubated with wastewater treatment sludge according to OECD301F. The amount of oxygen consumed by the microorganisms during biodegradation is followed using a manometric respirometer (Oxitop® bottle head). From the oxygen uptake, the biodegradation extent can be computed:
Spray drying aid 12: 55-60% after 28 days

### Biodegradability According to OECD301B

Spray Drying Aid 15 vs. Spray Drying Aid 16:

The test polymer (spray drying aid 15) is incubated with wastewater treatment sludge according to OECD301B. The amount of developed CO₂ during biodegradation is followed. From CO₂ evolution, the biodegradation extent can be computed.
Spray drying aid 15: 30-40% after 28 days
Spray drying aid 16: <10% after 28 days

1.-24. (canceled)

25. A pyrrolidone-containing polymer (PP) comprising at least one monomeric unit of the general formulae (I) to (II) 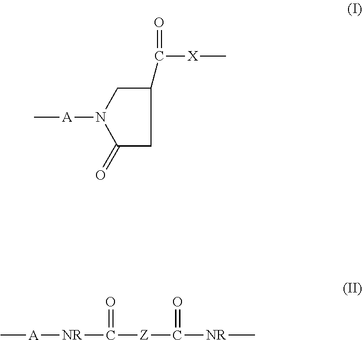
wherein R is independently hydrogen or C₁-C₂-alkyl;
X is —NR;
A is independently selected from the group consisting of C₁-C₂₀-alkanediyl, which carries at least one functional group C(═O)R², wherein
R² is selected from the group consisting of Cl, Br and OR³, wherein
R³ is selected from the group consisting of H, C₁-C₁₀-alkyl, C₃-C₁₀-cycloalkyl and C₂-C₁₅-alkenyl;
Z is a group of formula (IV) 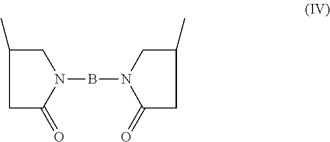
in which B is C₁-C₂₀-alkylene, which carries at least one functional group —COOH, or a mixture of the group of formula (IV) with group A.

26. The pyrrolidone-containing polymer (PP) of claim 25, wherein
(1) A is C₁-, C₂-, C₃-, C₄-, C₅- or C₆-alkanediyl or
(2) B is C₁-, C₂-, C₃-, C₄-, C₅- or C₆-alkanediyl.

27. The pyrrolidone-containing polymer (PP) according to claim 25, wherein the pyrrolidone-containing polymer (PP) is formed by polymerization of a reactive mixture (rM2), wherein the reactive mixture (rM2) comprises:
(A) at least one itaconic acid derivative, and
(B) at least one amino acid of the general formula (1) 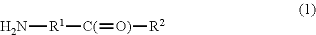
wherein
R¹ is selected from the group consisting of at least monosubstituted C₂-C₂₀ alkanediyl, wherein the substituent is NH₂;
R² is selected from the group consisting of Cl, Br and OR³, wherein
R³ is selected from the group consisting of H, C₁-C₁₀ alkyl, C₃-C₁₀ cycloalkyl and C₂-C₁₅ alkenyl.

28. The pyrrolidone-containing polymer (PP) according to claim 27, wherein the at least one itaconic acid derivative and the at least one amino acid of the general formula (1) are present in the reactive mixture (rM2) in a molar ratio of 10:1 to 1:10.

29. A process of manufacturing a re-dispersible dispersion powder (RDP), the process comprising the steps of
i) mixing a pyrrolidone-containing polymer (PP) comprising at least one unit of the general formulae (I) to (III) 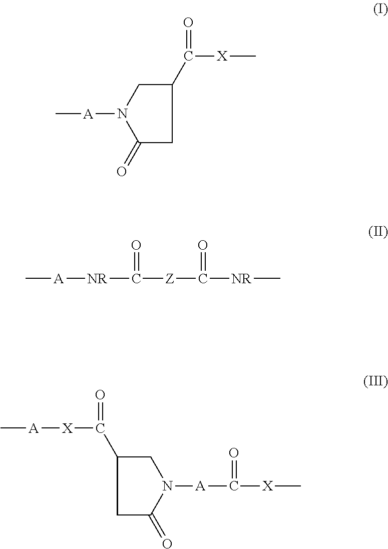
wherein R is independently hydrogen, C₁-C₄-alkyl, or two radicals R are linked to one another to form a six-membered ring;
X is —O— or —NR;
A is independently selected from the group consisting of C₁-C₂₀-alkanediyl, C₃-C₂₀-cycloalkanediyl, and C₆-C₂₀-arylene,
wherein the C₁-C₂₀-alkanediyl can be optionally interrupted by one or more non-adjacent oxygen atoms, sulfur atoms, or functional groups —NR— where the nitrogen atom can be optionally protonated or quarternized, —CO—, —CO—O—, —CO—NR—, —SO—, or —SO₂—,
wherein the C₁-C₂₀-alkanediyl and the C₃-C₂₀-cycloalkanediyl can optionally carry at least one functional group selected from the group consisting of C(═O)R² and SO₃H, wherein
R² is selected from the group consisting of Cl, Br and OR³, wherein
R³ is selected from the group consisting of H, C₁-C₁₀ alkyl, C₃-C₁₀ cycloalkyl and C₂-C₁₅ alkenyl,
wherein the C₆-C₂₀-arylene can be optionally interrupted by oxygen, sulfur, —NR—, —SO—, or —SO₂— and can be optionally substituted by —COOH or —SO₃H, or a mixture of such groups;
Z is a group of formula (IV) 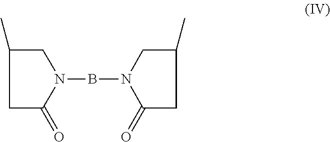
in which B is C₁-C₂₀-alkanediyl, which can be optionally interrupted by one or more non-adjacent oxygen atoms, sulfur atoms or functional groups —NR— where the nitrogen atom can be optionally protonated or quaternized, —CO—, —CO—O—, —CO—NR—, —SO— or —SO₂—, and can optionally carry additional functional groups —COOH or —SO₃H, C₆-C₂₀-cycloalkanediyl or a mixture of such groups
or a mixture of the group of formula (IV) with group A
with an aqueous polymer dispersion; and
ii) spray drying the mixture obtained in step i).

30. The process according to claim 29, wherein in step i) the pyrrolidone-containing polymer (PP) is mixed with the aqueous polymer dispersion in an amount of 4 to 20 wt.-%, based on the solid content of the aqueous polymer dispersion.

31. A re-dispersible dispersion powder (RDP) obtained by a process according to claim 29.

32. A re-dispersible dispersion powder (RDP) comprising a (co)polymer selected from the group consisting of acrylic acid ester polymer, acrylic-styrene copolymer, styrene-butadiene-based copolymer, vinyl acetate polymer, and ethylene-vinyl acetate copolymer and a pyrrolidone-containing polymer (PP) comprising at least one unit of the general formulae (I) to (III) 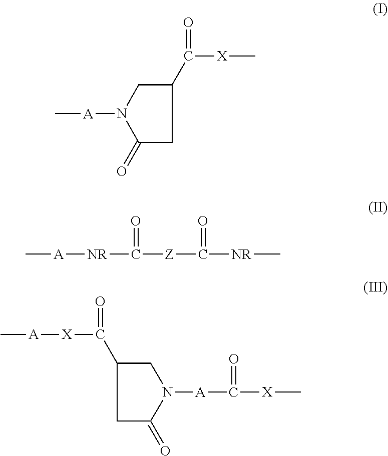
wherein R is independently hydrogen, C₁-C₄-alkyl, or two radicals R are linked to one another to form a six-membered ring;
X is —O— or —NR;
A is independently selected from the group consisting of C₁-C₂₀-alkanediyl, C₃-C₂₀-cycloalkanediyl, and C₆-C₂₀-arylene,
wherein the C₁-C₂₀-alkanediyl can be optionally interrupted by one or more non-adjacent oxygen atoms, sulfur atoms, or functional groups —NR— where the nitrogen atom can be optionally protonated or quarternized, —CO—, —CO—O—, —CO—NR—, —SO—, or —SO₂—,
wherein the C₁-C₂₀-alkanediyl and the C₃-C₂₀-cycloalkanediyl can optionally carry at least one functional group selected from the group consisting of C(═O)R² and SO₃H, wherein
R² is selected from the group consisting of Cl, Br and OR³, wherein
R³ is selected from the group consisting of H, C₁-C₁₀ alkyl, C₃-C₁₀ cycloalkyl and C₂-C₁₅ alkenyl,
wherein the C₆-C₂₀-arylene can be optionally interrupted by oxygen, sulfur, —NR—, —SO—, or —SO₂— and can be optionally substituted by —COOH or —SO₃H, or a mixture of such groups;
Z is a group of formula (IV) 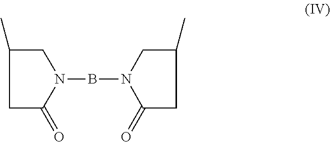
in which B is C₁-C₂₀-alkanediyl, which can be optionally interrupted by one or more non-adjacent oxygen atoms, sulfur atoms or functional groups —NR—, where the nitrogen atom can be optionally protonated or quaternized, —CO—, —CO—O—, —CO—NR—, —SO— or —SO₂—, and can optionally carry additional functional groups —COOH or —SO₃H, C₆-C₂₀-cycloalkanediyl or a mixture of such groups
or a mixture of the group of formula (IV) with group A
or a polymer according to claim 25.

33. A process of manufacturing a powder paint or a coating comprising blending the re-dispersible dispersion powder (RDP) according to claim 31 with a pigment.

34. A process of manufacturing a construction material composition comprising blending the re-dispersible dispersion powder (RDP) according to claim 31 with cement.

35. The pyrrolidone-containing polymer (PP) according to claim 27, wherein component (A) is selected from the group consisting of itaconic acid, itaconic anhydride, itaconic esters and itaconyl halides.

36. The pyrrolidone-containing polymer (PP) according to claim 27, wherein component (B) is selected from the group consisting of L-Lysine, D-Lysine and racemic mixtures of L-Lysine and D-Lysine.

37. The pyrrolidone-containing polymer (PP) according to claim 27, wherein the pyrrolidone-containing polymer (PP) comprises at least one unit of the general formula (A) 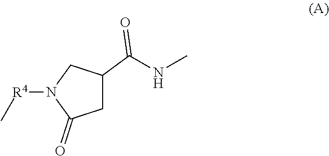
wherein
R⁴ is selected from the group consisting of at least monosubstituted C₂-C₂₀ alkanediyl and C₃-C₂₀ cycloalkanediyl, wherein at least one substituent is C(═O)R², wherein
R² is selected from the group consisting of Cl, Br and OR³, wherein
R³ is selected from the group consisting of H, C₁-C₁₀ alkyl, C₃-C₁₀ cycloalkyl and C₂-C₁₅ alkenyl.

38. The pyrrolidone-containing polymer (PP) according to claim 27, wherein the reactive mixture (rM2) comprises in the range from 0.5 to 70% by weight of component (A) and in the range from 30 to 99.5% by weight of component (B) based on the total weight of the reactive mixture (rM2).

39. The pyrrolidone-containing polymer (PP) according to claim 27, wherein the reactive mixture (rM2) comprises additional component (C), at least one catalyst selected from the group consisting of phosphoric acid, alkali metal dihydrogen phosphates, alkali metal hypophosphites, alkali metal hydrogen sulfates, tin octanoate, Titanium(IV) Butoxide and Bismuth 2,2-diphenylundecanote.

40. A process for producing a pyrrolidone-containing polymer (PP), wherein the process comprises polymerization of a reactive mixture (rM2), wherein the reactive mixture (rM2) comprises at least the following components
(A) at least one itaconic acid derivative, and
(B) at least one amino acid of the general formula (1) 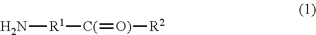
wherein
R¹ is selected from the group consisting of at least monosubstituted C₂-C₂₀ alkanediyl and at least monosubstituted C₃-C₂₀ cycloalkanediyl, wherein the substituent is NH₂, with the NH₂ substituent optionally being located on the most distal carbon atom;
R² is selected from the group consisting of Cl, Br and OR³, wherein
R³ is selected from the group consisting of H, C₁-C₁₀ alkyl, C₃-C₁₀ cycloalkyl and C₂-C₁₅ alkenyl.

41. The process according to claim 40, wherein the at least one amino acid of formula (1) is selected from the group consisting of L-Lysine, D-Lysine and racemic mixtures of L-Lysine and D-Lysine.

42. The process according to claim 40, wherein the reactive mixture (rM2) comprises additionally component (C), at least one catalyst selected from the group consisting of phosphoric acid, alkali metal dihydrogen phosphates, alkali metal hypophosphites, alkali metal hydrogen sulfates, tin octanoate, Titanium(IV) Butoxide and Bismuth 2,2-diphenylundecanoate.

43. The process according to claim 40, wherein the polymerization of the reactive mixture (rM2) comprises the following steps:
a) heating the reactive mixture (rM2) in the presence of at least one solvent (S) to a first temperature (T1) to obtain a prepolymerized mixture (pM2) comprising pyrrolidone-containing prepolymers and the at least one solvent (S),
b) removing the at least one solvent (S) from the prepolymerized mixture (pM2) obtained in step a) to obtain a solvent-free prepolymerized mixture (spM2), comprising the pyrrolidone-containing prepolymers,
c) heating the solvent-free prepolymerized mixture (spM2) obtained in step b) to a second temperature (T2) which is higher than the first temperature (T1) to obtain the pyrrolidone-containing polymer (PP).

44. The process according to claim 40, wherein the process additionally comprises at least one step selected from the group consisting of a hydrophobizing step, an alkoxylation step and a quaternization step.
